(19) United States
(12) Patent Application Publication
(10) Pub. No.: US 2023/0146229 A1
(43) Pub. Date: May 11, 2023

(54) ENTITY, GATEWAY DEVICE, INFORMATION PROCESSING DEVICE, INFORMATION PROCESSING SYSTEM, AND INFORMATION PROCESSING METHOD

(71) Applicant: SONY GROUP CORPORATION, TOKYO (JP)

(72) Inventor: TATSUYA IGARASHI, TOKYO (JP)

(21) Appl. No.: 17/911,638

(22) PCT Filed: Mar. 9, 2021
(86) PCT No.: PCT/JP2021/009144

§ 371 Date: Sep. 14, 2022

(30) Foreign Application Priority Data
Mar. 23, 2020 (JP) 2020-051455

(51) Int. Cl. H04L 9/32; H04L 9/14; H04L 9/00; H04L 9/08

(52) U.S. Cl. CPC H04L 9/3268; H04L 9/14; H04L 9/008; H04L 9/0866

(57) ABSTRACT

The present technology relates to an entity, a gateway device, an information processing device, an information processing system, and an information processing method capable of suppressing privacy damage to a user. An entity includes: a first recording unit that records a secret key, a private key, and a public key; and a generation unit that generates a data ID from data and calculates a nonce from the data and the secret key. The generation unit generates an entity derived ID on the basis of the entity ID calculated from the public key and the nonce and generates a certificate including a certificate message including the data ID and the entity derived ID, and a signature for the certificate message with the nonce and a derived private key generated from the private key. A gateway device includes: a second recording unit that records the secret key; and a first control unit that calculates the nonce from the secret key and the certificate or the data. An information processing device includes a second control unit that verifies the signature of the certificate from the certificate and the nonce. The present technology can be applied to an information processing system.

### TECHNICAL FIELD

The present technology relates to an entity, a gateway device, an information processing device, an information processing system, and an information processing method, and more particularly to, an entity, a gateway device, an information processing device, an information processing system, and an information processing method capable of inhibiting privacy damage to a user.

### BACKGROUND ART

In recent years, many services using peer-to-peer databases such as blockchains have been proposed.

For example, copyright management services for verifying authenticity of image data generated by cameras or data obtained by processing the image data, data distribution management services for tracing relationships between data of processing sources and processed data, and the like have been proposed as such services (see, for example, Patent Document 1).

However, depending on mechanisms of these services, verification of authenticity of each piece of data and tracing of the relationships between the processed data may not be appropriately realized.

For example, in order to trace the relationships between the data of the processing sources and the processed data, all the data to be traced needs to be sequentially registered in the blockchains. Therefore, management of the registered data becomes complicated and the operation cost of the services increases.

### CITATION LIST

### Patent Document

Patent Document 1: Japanese Patent Application Laid-Open No. 2018-117287

### SUMMARY OF THE INVENTION

### Problems to be Solved by the Invention

Therefore, it is conceivable to realize the tracing of the relationships of each piece of data without registering all the data in the blockchains by storing trace data for tracing the relationships with the data of the processing sources in files including the processed data.

However, in such cases, if certificates obtained by signing the trace data with secret keys are included or certificates of devices are recorded in blockchains, privacy damage to the user may not be sufficiently inhibited.

For example, in a case where an elliptic curve digital signature algorithm (ECDSA) (elliptic curve cryptography) is adopted as an encryption scheme, there is a possibility of public keys of the devices being restored from the certificates included in the trace data. That is, the public keys are likely to be leaked from the trace data for a number of reasons.

In recent years, due to an increase in privacy awareness, public keys of such devices and metadata of data may also be considered to be close to personal information. Therefore, it is necessary to inhibit leakage of the public keys of the devices from the viewpoint of privacy.

In addition, for example, when IDs of the devices are specified from the certificates of the devices, a plurality of pieces of data is likely to be specified as data generated by the same devices with regard to data registered in the blockchains or data not registered in the blockchains from the IDs of the devices.

Further, for example, in a case where nodes of the blockchains are hacked, public keys of devices, personal information of users, and the like are likely to be leaked and abused.

In particular, in blockchains, when information regarding users, such as personal information and public keys of devices, is recorded in association with each other, in a case where one piece of information is leaked, all the other associated information may also be leaked and identification of information regarding an individual user may be accordingly specified.

In this case, not only the information on the blockchains but also information regarding other users on networks, such as information regarding social networking services (SNSs), is likely to be specified from the leaked information regarding the users.

The present technology has been made in view of such circumstances and an objective of the present technology is to inhibit privacy damage to users.

### Solutions to Problems

An information processing system according to a first aspect of the present technology is an information processing system including an entity, a gateway device, and an information processing device.

The entity includes a first recording unit that records a pre-generated secret key, a private key, and a public key, and a generation unit that generates a data ID of predetermined data on the basis of the data and calculates a nonce on the basis of the data and the secret key.

The generation unit generates an entity derived ID on the basis of an entity ID for identifying the entity calculated on the basis of the public key and the nonce, and generates a certificate of the data that includes a certificate message including the data ID and the entity derived ID and a signature for the certificate message with the nonce and a derived private key generated on the basis of the private key or includes a signature for the certificate message with the private key and the certificate message partially encrypted and replaced with the nonce.

The gateway device includes a second recording unit that records the secret key, a first control unit that calculates the nonce on the basis of the secret key and the certificate or the data acquired from the entity, and a first communication unit that transmits the certificate and the nonce to the information processing device.

The information processing device includes a second communication unit that receives the certificate and the nonce transmitted by the gateway device, and a second control unit that verifies a signature of the certificate of the entity on the basis of the certificate and the nonce.

An information processing method according to the first aspect of the present technology is an information processing method of an information processing system including an entity that records a pre-generated secret key, a private key, and a public key, a gateway device that records the secret key, and an information processing device.

The entity

generates a data ID of predetermined data on the basis of the data and calculates a nonce on the basis of the data and the secret key,

generates an entity derived ID on the basis of an entity ID for identifying the entity calculated on the basis of the public key and the nonce, and

generates a certificate of the data that includes a certificate message including the data ID and the entity derived ID and a signature for the certificate message with the nonce and a derived private key generated on the basis of the private key or includes a signature for the certificate message with the private key and the certificate message partially encrypted and replaced with the nonce.

The gateway device

calculates the nonce on the basis of the secret key and the certificate or the data acquired from the entity, and

transmits the certificate and the nonce to the information processing device.

The information processing device

receives the certificate and the nonce transmitted by the gateway device, and

verifies a signature of the certificate of the entity on the basis of the certificate and the nonce.

According to the first aspect of the present technology, an information processing system includes an entity that records a pre-generated secret key, a private key, and a public key, a gateway device that records the secret key, and an information processing device.

The entity generates a data ID of predetermined data on the basis of the data and calculates a nonce on the basis of the data and the secret key, generates an entity derived ID on the basis of an entity ID for identifying the entity calculated on the basis of the public key and the nonce, and generates a certificate of the data that includes a certificate message including the data ID and the entity derived ID and a signature for the certificate message with the nonce and a derived private key generated on the basis of the private key or includes a signature for the certificate message with the private key and the certificate message partially encrypted and replaced with the nonce.

The gateway device calculates the nonce on the basis of the secret key and the certificate or the data acquired from the entity, and transmits the certificate and the nonce to the information processing device.

The information processing device receives the certificate and the nonce transmitted by the gateway device, and verifies a signature of the certificate of the entity on the basis of the certificate and the nonce.

According to a second aspect of the present technology, an entity includes:

a recording unit configured to record a pre-generated secret key, a private key, and a public key; and

a generation unit configured to generate a data ID of predetermined data on the basis of the data and calculate a nonce on the basis of the data and the secret key, to generate an entity derived ID on the basis of an entity ID for identifying the entity calculated on the basis of the public key and the nonce, and to generate a certificate of the data that includes a certificate message including the data ID and the entity derived ID and a signature for the certificate message with the nonce and a derived private key generated on the basis of the private key or includes a signature for the certificate message with the private key and the certificate message partially encrypted and replaced with the nonce.

An information processing method according to the second aspect of the present technology is an information processing method of an entity recording a pre-generated secret key, a private key, and a public key.

The method includes

generating a data ID of predetermined data on the basis of the data and calculating a nonce on the basis of the data and the secret key;

generating an entity derived ID on the basis of an entity ID for identifying the entity calculated on the basis of the public key and the nonce; and

generating a certificate of the data that includes a certificate message including the data ID and the entity derived ID and a signature for the certificate message with the nonce and a derived private key generated on the basis of the private key or includes a signature for the certificate message with the private key and the certificate message partially encrypted and replaced with the nonce.

According to the second aspect of the present technology, an entity recording a pre-generated secret key, a private key, and a public key

generates a data ID of predetermined data on the basis of the data and calculates a nonce on the basis of the data and the secret key,

generates an entity derived ID on the basis of an entity ID for identifying the entity calculated on the basis of the public key and the nonce, and

generates a certificate of the data that includes a certificate message including the data ID and the entity derived ID and a signature for the certificate message with the nonce and a derived private key generated on the basis of the private key or includes a signature for the certificate message with the private key and the certificate message partially encrypted and replaced with the nonce.

According to a third aspect of the present technology, a gateway device includes:

a communication unit configured to acquire a certificate of predetermined data generated by an entity recording a pre-generated secret key, a private key, and a public key and the data, the certificate including a certificate message including a data ID and an entity derived ID, and a signature for the certificate message with a nonce and a derived private key generated on the basis of the private key, or the certificate including a signature for the certificate message with the private key, and the certificate message partially encrypted and replaced by the nonce;

a recording unit configured to record the secret key; and

a control unit configured to calculate the nonce on the basis of the secret key and the acquired certificate or data.

The communication unit transmits the certificate and the nonce to an information processing device.

The data ID is generated on the basis of the data.

The entity derived ID is generated on the basis of the nonce and an entity ID for identifying the entity calculated on the basis of the public key.

An information processing method according to the third aspect of the present technology is an information processing method of a gateway device recording a secret key.

The method includes:

acquiring a certificate of predetermined data generated by an entity recording the secret key which is pre-generated, a private key, and a public key and the data, the certificate including a certificate message including a data ID and an entity derived ID, and a signature for the certificate message with a nonce and a derived private key generated on the basis of the private key, or the certificate including a signature for the certificate message with the private key, and the certificate message partially encrypted and replaced by the nonce;

calculating the nonce on the basis of the secret key and the acquired certificate or data; and

transmitting the certificate and the nonce to an information processing device.

The data ID is generated on the basis of the data.

The entity derived ID is generated on the basis of the nonce and an entity ID for identifying the entity calculated on the basis of the public key.

According to the third aspect of the present technology, a gateway device recording a secret key

acquires a certificate of predetermined data generated by an entity recording the secret key which is pre-generated, a private key, and a public key, the certificate including a certificate message including a data ID and an entity derived ID, and a signature for the certificate message with a nonce and a derived private key generated on the basis of the private key, or the certificate including a signature for the certificate message with the private key, and the certificate message partially encrypted and replaced by the nonce;

calculates the nonce on the basis of the secret key and the acquired certificate or data; and

transmits the certificate and the nonce to an information processing device.

The data ID is generated on the basis of the data.

The entity derived ID is generated on the basis of the nonce and an entity ID for identifying the entity calculated on the basis of the public key.

According to a fourth aspect of the present technology, an information processing device includes:

a communication unit configured to receive a certificate of predetermined data generated by an entity recording a pre-generated secret key, a private key, and a public key and a nonce, the certificate including a certificate message including a data ID and an entity derived ID, and a signature for the certificate message with the nonce and a derived private key generated on the basis of the private key, or the certificate including a signature for the certificate message with the private key, and the certificate message partially encrypted and replaced by the nonce; and

a control unit configured to verify the signature for the certificate of the entity on the basis of the certificate and the nonce.

The data ID is generated on the basis of the data.

The nonce is calculated on the basis of the secret key and the certificate or the data.

The entity derived ID is generated on the basis of the nonce and an entity ID for identifying the entity calculated on the basis of the public key.

According to the fourth aspect of the present technology, an information processing method of an information processing device includes:

receiving a certificate of predetermined data generated by an entity recording a pre-generated secret key, a private key, and a public key and a nonce, the certificate including a certificate message including a data ID and an entity derived ID, and a signature for the certificate message with the nonce and a derived private key generated on the basis of the private key, or the certificate including a signature for the certificate message with the private key, and the certificate message partially encrypted and replaced by the nonce; and

verifying the signature for the certificate of the entity on the basis of the certificate and the nonce.

The data ID is generated on the basis of the data.

The nonce is calculated on the basis of the secret key and the certificate or the data.

The entity derived ID is generated on the basis of the nonce and an entity ID for identifying the entity calculated on the basis of the public key.

According to the fourth aspect of the present technology, an information processing device

receives a certificate of predetermined data generated by an entity recording a pre-generated secret key, a private key, and a public key and a nonce, the certificate including a certificate message including a data ID and an entity derived ID, and a signature for the certificate message with the nonce and a derived private key generated on the basis of the private key, or the certificate including a signature for the certificate message with the private key, and the certificate message partially encrypted and replaced by the nonce; and

verifies the signature for the certificate of the entity on the basis of the certificate and the nonce.

The data ID is generated on the basis of the data.

The nonce is calculated on the basis of the secret key and the certificate or the data.

The entity derived ID is generated on the basis of the nonce and an entity ID for identifying the entity calculated on the basis of the public key.

### BRIEF DESCRIPTION OF DRAWINGS

FIG. 1 is a diagram illustrating a configuration of a traceability system.

FIG. 2 is a diagram illustrating an exemplary configuration of a service supply device and an information processing device.

FIG. 3 is a diagram illustrating an example of a user database and a blockchain database.

FIG. 4 is a diagram illustrating an exemplary configuration of a manufacturer device and an entity.

FIG. 5 is a flowchart illustrating entity registration request processing and an entity registration process.

FIG. 6 is a flowchart illustrating a file generation process.

FIG. 7 is a flowchart illustrating data registration request processing and a data registration process.

FIG. 8 is a flowchart illustrating verification request processing and a verification process.

FIG. 9 is a diagram illustrating generation of File 1.

FIG. 10 is a diagram illustrating generation of File 2.

FIG. 11 is a diagram illustrating an exemplary configuration of an entity.

FIG. 12 is a flowchart illustrating a file generation process.

FIG. 13 is a diagram illustrating generation of File 1.

FIG. 14 is a diagram illustrating generation of File 0.

FIG. 15 is a diagram illustrating an exemplary configuration of a computer.

### MODE FOR CARRYING OUT THE INVENTION

Hereinafter, embodiments to which the present technology is applied will be described with reference to the drawings.

### First Embodiment

<Exemplary Configuration of Traceability System>

The present technology is capable of inhibiting privacy damage to a user by performing an electronic signature (hereinafter simply referred to as a signature) with a derived private key derived from a private key of an entity on the basis of a secret key of the entity and generated data without recording a public key of an entity in a blockchain.

For example, the present technology can be applied to a traceability system or the like that generates a file in which a certificate signed through public key encryption is added to data generated by an entity corresponding to a device such as a camera and certifies authenticity of the data by the certificate using a blockchain.

In the traceability system to which the present technology is applied, leakage of a public key of elliptical encryption or the like from a file can be inhibited, and leakage of a public key of a device and user information can be inhibited even when a blockchain is hacked.

Note that the present technology can be applied not only to a traceability system but also to any other system, but a case where the present technology is applied to a traceability system using a blockchain will be described below as a specific example. In addition, in the following description, a case where elliptic curve cryptography (ECDSA) is used as an encryption scheme will be described as an example, but other encryption schemes may be used.

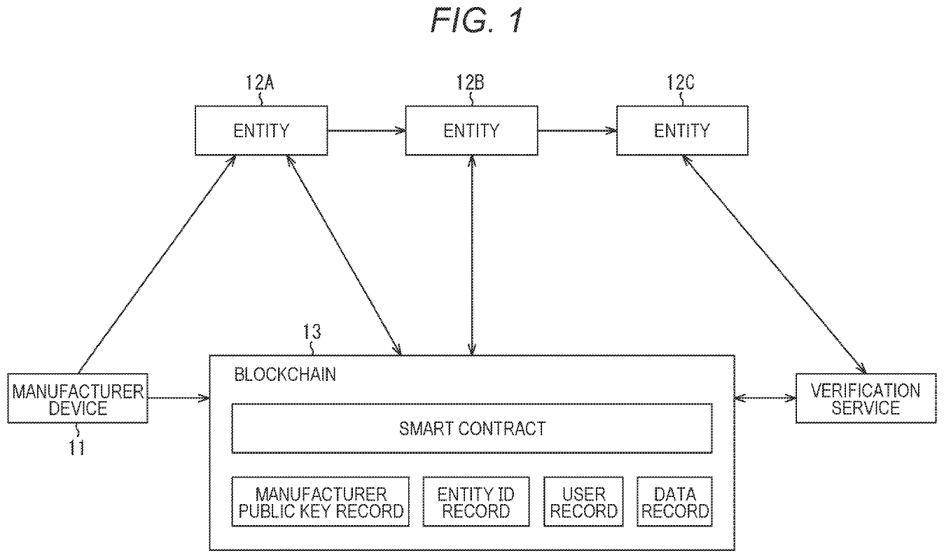

FIG. 1 is a diagram illustrating an exemplary configuration of an embodiment of a traceability system which is an example of an information processing system to which the present technology is applied.

The traceability system illustrated in FIG. 1 includes a manufacturer device 11, entities 12A to 12C, and a blockchain 13.

Note that, in the following description, in a case where it is not necessary to particularly distinguish the entities 12A to 12C from each other, the entities are also simply referred to as the entities 12.

The manufacturer device 11 is an information processing device including, for example, a personal computer (PC) or the like managed by a manufacturer of any device such as an Internet of Things (IoT) device corresponding to the entity 12.

In addition, in this example, the device includes a camera, a smartphone, a tablet, a PC, other portable devices, and the like manufactured by a manufacturer that manages the manufacturer device 11.

Note that each entity 12 may be realized by hardware or software different from each other in the same device or may be realized by hardware or software of different devices.

The manufacturer device 11 registers, in the blockchain, ID information for identifying the manufacturer device 11 itself, that is, the manufacturer, and a certificateₛ of a public key K_{mak_pub} that is paired with a private key K_{mak_pri} of the manufacturer held by the manufacturer device 11.

The manufacturer device 11 generates, for the entity 12A, a pair of private key K_{pri_entity-A} and public key K_{pub_entity-A} of elliptic curve cryptography, and a certificate Cert_{entity-A} of the public key K_{pub_entity-A}. The manufacturer device 11 supplies the private key K_{pri_entity-A} and the certificate Cert_{entity-A} to the entity 12A to record the private key and the certificate.

Similarly, the manufacturer device 11 generates a private key and a public key of each entity 12 for the entity 12B and the entity 12C and a certificate of the public key, and supplies the private key and the certificate to the entity 12 to record the private key and the certificate.

For example, the supply of the private key and the certificate to the entity 12 is performed before shipment of the entity 12, but may be performed after the shipment.

The entity 12A is realized by, for example, a device such as a camera and functions as a generation device that generates data to be traced. That is, the entity 12A generates original data to be traced and directly or indirectly supplies a file including the data to the entity 12B.

Here, the original data to be traced may be any data such as image data and audio data generated by the entity 12A. Hereinafter, a case where the entity 12A is a camera and generates image data as data to be traced will be described as a specific example.

In addition, in the following description, the original data generated by the entity 12A is also particularly referred to as Data 0, and a file including Data 0 is also referred to as File 0.

File 0 also includes trace data (hereinafter also referred to as Trace Data 0) for tracing a relationship between Data 0 and data obtained by processing Data 0, that is, a relationship (a master-slave relationship) between the data before the processing and the data after the processing.

In addition, the entity 12A is connected to the blockchain 13 via a wired or wireless network such as the Internet, and appropriately registers information regarding the entity 12A or an individual user who is an owner of the entity 12A, File 0, and the like.

The entity 12B processes Data 0 included in File 0 on the basis of File 0 generated by the entity 12A, generates new data, and also generates a new file including the data.

Note that, hereinafter, the data generated by processing Data 0 in the entity 12B is also particularly referred to as Data 1, and the file including Data 1 is also referred to as File 1. In addition, File 1 also includes Trace Data 1 obtained by updating Trace Data 0 along with Data 1.

Further, in the following description, new data obtained by processing certain data is also referred to as processed data or slave data, and data on which the processed data is based is also referred to as processing source data or master data. For example, when Data 0 is processed to generate Data 1, Data 0 is the processing source data (master data), and Data 1 is the processed data (slave data).

File 1 generated in the entity 12B is supplied directly or indirectly from the entity 12B to the entity 12C.

In addition, the entity 12B is connected to the blockchain 13 via a network or the like and appropriately registers File 1, that is, Trace Data 1 or the like.

On the basis of File 1 generated by the entity 12B, the entity 12C processes Data 1 included in File 1 to generate new processed data and also generates a new file including the processed data.

Note that, hereinafter, the processed data generated from Data 1 is also particularly referred to as Data 2, and the file including Data 2 is also referred to as File 2. In addition, File 2 also includes Trace Data 2 obtained by updating Trace Data 1 along with Data 2.

Further, for example, the entity 12C can appropriately supply File 2 to a device that supplies a verification service and requests the device to perform tracing or the like of a relationship of Data 0 to Data 2. Similarly, the entities 12A and 12B can supply files to devices supplying validation services and request the device to perform tracking or the like of data.

For example, in the verification service, the blockchain 13 is used to verify the certificate for each data included in the file, that is, verify the authenticity of each piece of data, and the relationship between the pieces of data is traced.

In addition, for example, in a case where the trace data includes digest data indicating content of each piece of data, comparison between the pieces of data such as presence or absence of counterfeiting is performed by determining similarity between the pieces of data using the digest data in the verification service.

Note that the digest data is, for example, metadata incidental to the data. Specifically, for example, in a case where data is image data, metadata such as exchangeable image file format (EXIF) of the image data is digest data. The EXIF includes positional information such as an imaging date and time and an imaging place of an image and a thumbnail image.

Accordingly, if there is a file of the processed data, although the processing source data itself cannot be obtained, the thumbnail image included in the digest of the processing source data in the trace data of the file can be compared with the image as the processed data, and similarity between the images can be determined. Thus, on the basis of the determination result of similarity, for example, counterfeiting of processed data, copyright determination, and the like can be performed

The provision of such a verification service may be performed by a dedicated information processing device capable of accessing the blockchain or may be performed by a node or the like included in the blockchain 13.

The blockchain 13 is, for example, a consortium type P2P database which is managed by predetermined participants (consortium members) and includes a plurality of information processing devices which are nodes functioning as certificate authorities (CA), peers, and orderers.

In the blockchain 13, a predetermined node performs processing of logic agreed in advance between consortium members, such as reading and writing of data under certain conditions, by executing a program called a smart contract.

In particular, in this example, management of various kinds of data and verification regarding data such as tracing are performed in the blockchain 13. For example, the above-described verification service may be supplied by a node managed by a consortium member of the blockchain 13.

In addition, the blockchain 13 also manages a manufacturer public key record, an entity ID record, a user record, and a data record.

For example, the public key K_{mak_pub} or the like of a manufacturer is managed in the manufacturer public key record, and ID information for identifying each entity 12 is managed in the entity ID record. In addition, in the user record, information regarding the user who is the owner of a device corresponding to the entity 12 is managed. In the data record, ID information for identifying data generated or processed by the entity 12 is managed.

Note that, an example in which management of various kinds of data related to the tracing and the like is performed by the blockchain 13 will be described here. However, the present technology is not limited thereto, and the management may be performed by another P2P database (a P2P network), a general server, or the like.

<Exemplary Configurations of Service Supply Device and Information Processing Device>

Next, an exemplary configuration of an information processing device included the blockchain 13 will be described.

Note that, here, a case where the above-described verification service, registration related to various certificates, files (trace data), and the like are performed by a service supply device managed by a consortium member will be described.

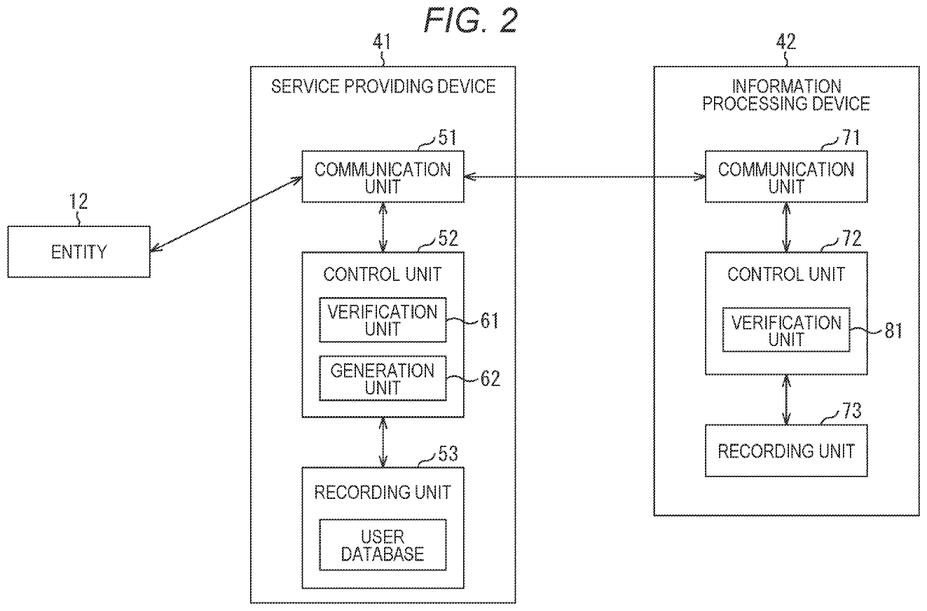

In such a case, for example, as illustrated in FIG. 2, the blockchain 13 includes a plurality of devices that include at least a service supply device 41 managed by a consortium member and an information processing device 42 functioning as a peer of the blockchain 13.

In FIG. 2, the service supply device 41 functions as a gateway device that supplies means for allowing a device corresponding to the entity 12 that is not a consortium member to access (connect) to the blockchain 13, for example, an application programming interface (API). That is, the entity 12 can access the blockchain 13 via the service supply device 41.

Note that the entity 12 may be connected to the service supply device 41 via a network or may be connected to the service supply device 41 via an interface such as a universal serial bus (USB). Additionally, for example, the entity 12 itself may perform a function of the service supply device 41 and may function as a gateway device.

The service supply device 41 includes a communication unit 51, a control unit 52, and a recording unit 53. Further, the control unit 52 includes a verification unit 61 and a generation unit 62.

The communication unit 51 communicates with an external device such as the information processing device 42, receives information transmitted from the device, and supplies the information to the control unit 52, or transmits the information supplied from the control unit 52 to the device.

The control unit 52 includes, for example, a processor or the like, and controls an operation of the entire service supply device 41. For example, the verification unit 61 verifies authenticity of a file (data) generated by the entity 12. In addition, the generation unit 62 generates, for example, information necessary for registration related to a file (data) generated by the entity 12.

The recording unit 53 includes a nonvolatile memory or the like, and records information supplied from the control unit 52 or supplies the recorded information to the control unit 52.

In particular, the recording unit 53 records (holds) a user database including information regarding a user who is an owner of the entity 12.

The information processing device 42 includes a communication unit 71, a control unit 72, and a recording unit 73. Further, the control unit 72 includes a verification unit 81.

The communication unit 71 communicates with the service supply device 41, receives information transmitted from the service supply device 41 and supplies the information to the control unit 72, and transmits information supplied from the control unit 72 to the service supply device 41.

The control unit 72 includes, for example, a processor or the like and controls an operation of the entire information processing device 42. For example, the verification unit 81 verifies a certificate (trace data) or the like related to the entity 12 supplied from the service supply device 41.

The recording unit 73 includes a nonvolatile memory or the like, and records information supplied from the control unit 72 or supplies the recorded information to the control unit 72.

In particular, the recording unit 73 functions as a database (blockchain database) of the blockchain 13 also called a distributed ledger or the like, and records the above-described manufacturer public key record, entity ID record, user record, data record, and the like. In other words, the recording unit 73 is a database distributed and recorded in each network node included in the blockchain 13.

<User Database and Blockchain Database>

Here, each piece of information such as the user database recorded in the service supply device 41 and the manufacturer public key record recorded in the information processing device 42 will be described.

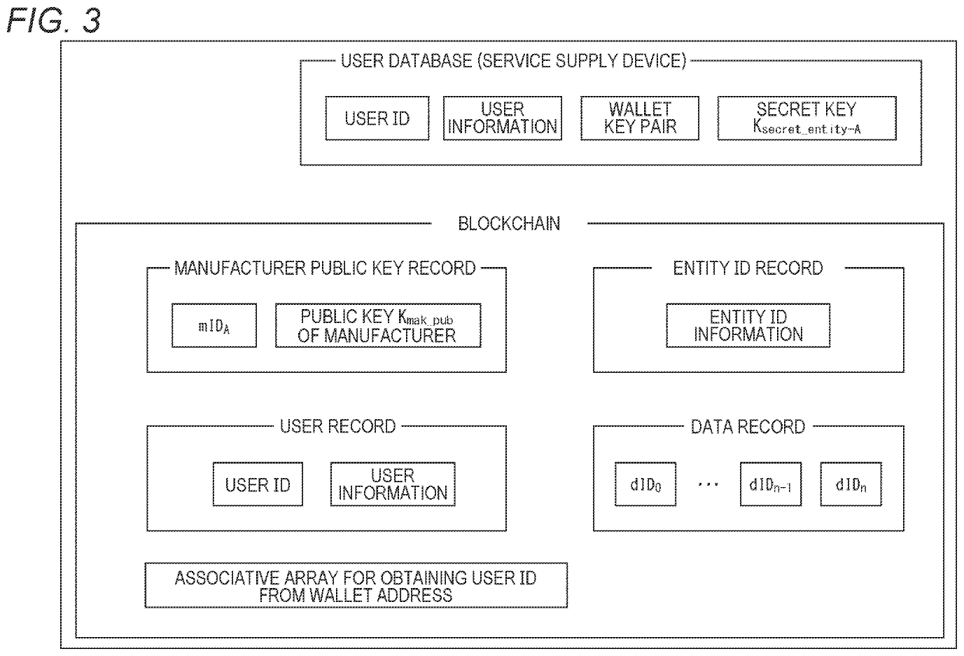

For example, as illustrated in the upper side of FIG. 3, in the user database recorded in the service supply device 41, a user ID, user information, a wallet key pair, and a secret key K_{secret_entity-A} of the entity 12 are recorded in association with each other for each user.

The user ID is ID information for identifying a user. The user information is, for example, information regarding a list of entity ID information of the entity 12 owned by an individual user or a user, such as a name and an address, and an e-mail address of the user.

In addition, the wallet key pair is a pair of public key and private key for generating a transaction of the user in the blockchain 13. An identifier generated by a cryptographic hash function from the public key is a wallet address, and the private key is used to sign the transaction. For example, the wallet address included in the transaction can be used to identify her the transaction is processing requested by a user and verify that the transaction was signed with the secret key of the user. Here, it is assumed that the wallet address is used as a user ID.

The secret key K_{secret_entity-A} of the entity 12 is a secret key that is independently generated in advance by the entity 12 itself and is held in the entity 12. The secret key K_{secret_entity-A} corresponding to the entity ID information included in the user information is managed.

Such a user database is not recorded in the blockchain database (the blockchain 13). Accordingly, for example, even if the node included in the blockchain 13 is hacked, the secret key K_{secret_entity-A} of the entity 12 is not leaked. Therefore, it is possible to inhibit privacy damage to the user.

Note that, in a case where the service supply device 41 is hacked, the secret key K_{secret_entity-A} of the owned entity 12 is likely to be leaked. However, since this leakage is leakage related to the user managed by the service supplier and privacy of the entire system is not damaged, the service supply device 41 does not become a single point of failure of the system.

In addition, a manufacturer public key record, an entity ID record, a user record, and a data record are recorded in the blockchain 13 (the blockchain database).

In the manufacturer public key record, for each manufacturer device 11, that is, for each manufacturer, ID information for identifying the manufacturer and the public key K_{mak_pub} of the manufacturer, more specifically, a certificate (Certificates) of the public key K_{mak_pub} are recorded in association.

In this example, for example, ID information mID_{A} for identifying the manufacturer of the entity 12A and the public key K_{mak_pub} of the manufacturer are recorded in association. For example, the ID information mID_{A} is obtained by obtaining a hash value of the public key K_{mak_pub} of the manufacturer.

In the entity ID record, entity ID information which is ID information for identifying the entity 12 is recorded. That is, the public key K_{pub_entity-A} of the entity 12 is not recorded in the blockchain 13.

In this example, the entity ID information is generated on the basis of the public key of the entity 12 generated by the manufacturer device 11. For example, the entity ID information eID_{A} of the entity 12A is a hash value or the like of the public key K_{pub_entity-A} of the entity 12.

Basically, in the blockchain database, the entity ID information is not associated (linked) with information such as a user ID.

Therefore, even if the entity ID record is hacked and the entity ID information is leaked, it is difficult to specify the entity 12 itself, the user ID indicating the user of the entity 12, and the like from the entity ID information. Thus, it is possible to inhibit privacy damage to the user.

In the user record, the user ID and the user information are recorded in association with each other. Note that, in the user record, a link (associative array key) for obtaining entity ID information from the user ID is also recorded for the user ID.

In the data record, data ID information dID₀ that is ID information indicating original Data 0, that is, file 0, and data ID information dID_{N} indicating each pieces of data N (where N=1, 2, . . . , n) generated from Data 0 are recorded in association with each other.

For example, the data ID information dIDₙ₋₁ and the data ID information dIDₙ are associated with the data ID information dID₀ of Data 0 in the data record. Therefore, it can be understood that Data n−1 and the data n indicated by the data ID information dIDₙ₋₁ and the data ID information dIDₙ are processed data generated from Data 0, and the data n is processed data (slave data) of the Data n−1.

In this example, the user ID or the like is not associated with the data ID information dID_{N} of each piece of data N and the data N itself or the public key K_{pub_entity-A} of the entity 12 is not recorded in the blockchain 13. Therefore, even if the data ID information dID_{N} or the like of the data N is leaked due to hacking, the data N, the user ID, and the entity 12 are not specified from the data ID information dID_{N}, and it is possible to minimize privacy damage to the user.

Further, in addition to the manufacturer public key record, the entity ID record, and the like described above, an associative array for obtaining the user ID from the wallet address is also recorded in the blockchain 13 (the blockchain database).

<Exemplary Configuration of Manufacturer Device and Entity>

Next, exemplary configurations of the manufacturer device 11 and the entity 12A and File 0 generated by the entity 12A will be described.

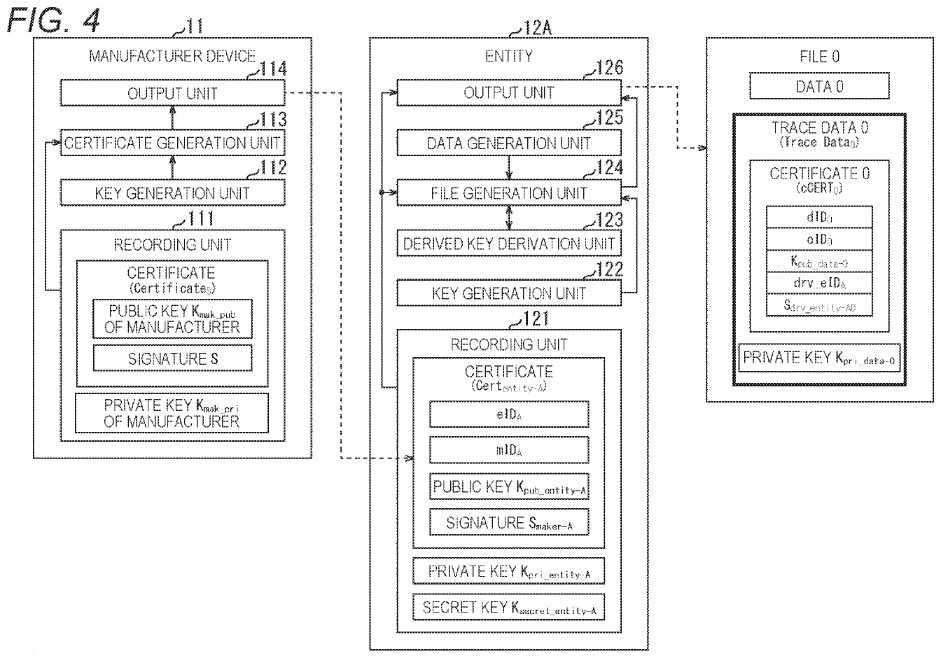

For example, as illustrated in FIG. 4, the manufacturer device 11 includes a recording unit 111, a key generation unit 112, a certificate generation unit 113, and an output unit 114.

The recording unit 111 records the private key K_{mak_pri} of the manufacturer, a certificate (Certificates) of the public key K_{mak_pub}, and the like and supplies the private key K_{mak_pri} and the certificate (Certificates) to the certificate generation unit 113 as necessary.

Here, the certificate (Certificates) includes the public key K_{mak_pub} of the manufacturer and a signature S. The signature S is obtained by electronically signing (encrypting) the public key K_{mak_pub} with the paired private key K_{mak_pri}. As described above, the certificate (Certificates) of the public key K_{mak_pub} is pre-registered (recorded) in the manufacturer public key record of the blockchain 13.

The key generation unit 112 generates the private key K_{pri_entity-A} and the public key K_{pub_entity-A} that are a pair of elliptic curve cryptography for the entity 12A, for example, using a random number or the like, and supplies the private key K_{pri_entity-A} and the public key K_{pub_entity-A} to the certificate generation unit 113.

The certificate generation unit 113 generates the certificate Cert_{entity-A} of the public key K_{pub_entity-A} on the basis of the private key K_{mak_pri} supplied from the recording unit 111 and the public key K_{pub_entity-A} supplied from the key generation unit 112, and supplies the output unit 114 with the certificate and the private key K_{pri_entity-A} supplied from the key generation unit 112.

The output unit 114 outputs the certificate Cert_{entity-A} and the private key K_{pri_entity-A} supplied from the certificate generation unit 113 and directly or indirectly supplies the entity 12A with the certificate Cert_{entity-A} and the private key K_{pri_entity-A}.

In addition, the entity 12A includes a recording unit 121, a key generation unit 122, a derived key derivation unit 123, a file generation unit 124, a data generation unit 125, and an output unit 126.

The recording unit 121 includes, for example, a nonvolatile memory and records in advance the certificate Cert_{entity-A} and the private key K_{pri_entity-A} supplied directly or indirectly from the manufacturer device 11, the secret key K_{secret_entity-A} generated by itself, and the like. In addition, the recording unit 121 supplies the recorded information to the file generation unit 124 and the output unit 126 as necessary.

For example, the certificate Cert_{entity-A} of the public key K_{pub_entity-A} recorded in the recording unit 121 includes entity ID information eID_{A} of the entity 12A, ID information mID_{A} for identifying a manufacturer (the manufacturer device 11), the public key K_{pub_entity-A} generated by the manufacturer device 11 for the entity 12A, and a signature S_{maker-A}.

The signature S_{maker-A} is obtained by electronically signing (encrypting) the entity ID information eID_{A}, the ID information mID_{A}, and the public key K_{pub_entity-A} with the private key K_{mak_pri} of the manufacturer device 11. The signature S_{maker-A}, that is, the certificate Cert_{entity-A}, may be verified with the public key K_{mak_pub} of the manufacturer device 11.

The key generation unit 122 generates a private key K_{pri_data-0} and a public key K_{pub_data-0} that form a pair of elliptic curve cryptography on the basis of a random number or the like for Data 0 generated by the entity 12A, and supplies the private key K_{pri_data-0} and the public key K_{pub_data-0} to the file generation unit 124.

Note that the secret key K_{secret_entity-A} of the entity 12A held in the recording unit 121 may also be generated by the key generation unit 122 on the basis of, for example, a random number or the like.

The derived key derivation unit 123 generates (derives) a derived private key K_{drv_pri_entity-A} of the entity 12A derived from the private key K_{pri_entity-A} on the basis of the private key K_{pri_entity-A} or the like supplied from the file generation unit 124, and supplies the derived private key K_{drv_pri_entity-A} to the file generation unit 124.

The file generation unit 124 generates File 0 on the basis of each piece of information supplied from the recording unit 121, the key generation unit 122, the derived key derivation unit 123, and the data generation unit 125, and supplies File 0 to the output unit 126.

The data generation unit 125 includes an image sensor or the like, generates Data 0 by imaging the surroundings as a subject, and supplies Data 0 to the file generation unit 124. In this example, for example, Data 0 is image data obtained by the imaging.

Note that metadata such as EXIF data of Data 0 may be supplied to the file generation unit 124 along with Data 0, and the encrypted metadata may be stored in File 0.

The output unit 126 outputs the information supplied from the recording unit 121 or the file generation unit 124. For example, the output unit 126 outputs File 0 supplied from the file generation unit 124 to the entity 12B and the service supply device 41.

File 0 generated by the file generation unit 124 includes Data 0 and Trace Data 0 (Trace Data₀) as illustrated on the right side in the drawing.

Trace Data 0 includes Certificate 0 (cCERT₀) for proving authenticity of Data 0 and the private key K_{pri_data-0}.

In addition, Certificate 0 (cCERT₀) includes data ID information dID₀ for identifying Data 0, operation ID information oID₀ for Data 0, the public key K_{pub_data-0} of Data 0, entity derived ID information drv_eID_{A}, and a signature S_{drv_entity-A0}.

Here, the operation ID information oID₀ is obtained by obtaining a hash value of the public key K_{pub_data-0}, and the entity derived ID information drv_eID_{A} is ID information derived from the entity ID information eID_{A}.

In addition, the signature S_{drv_entity-A0} is obtained by electronically signing (encrypting) an Msg hash value obtained from the data ID information dID₀, the public key K_{pub_data-0}, the operation ID information oID₀, and the entity derived ID information drv_eID_{A} with the derived private key K_{drv_pri_entity-A}.

The signature S_{drv_entity-A0} by the derived private key K_{drv_pri_entity-A}, that is, Certificate 0, can be verified (decrypted) by the derived public key K_{drv_pub_entity-A} corresponding to the derived private key K_{drv_pri_entity-A}.

In addition, the private key K_{pri_data-0} included in File 0 is used when the entity 12B generates File 1 including Data 1 obtained by processing Data 0, more specifically, when the entity generates Certificate 1 (cCERT₁) of Data 1.

<Description of Entity Registration Request Processing and Entity Registration Processing>

Next, the registration related to the entity 12 and File 0 performed between the entity 12A, the service supply device 41, and the information processing device 42 described above will be described.

For example, when a user purchases the entity 12, the user then registers the entity 12 in the blockchain 13.

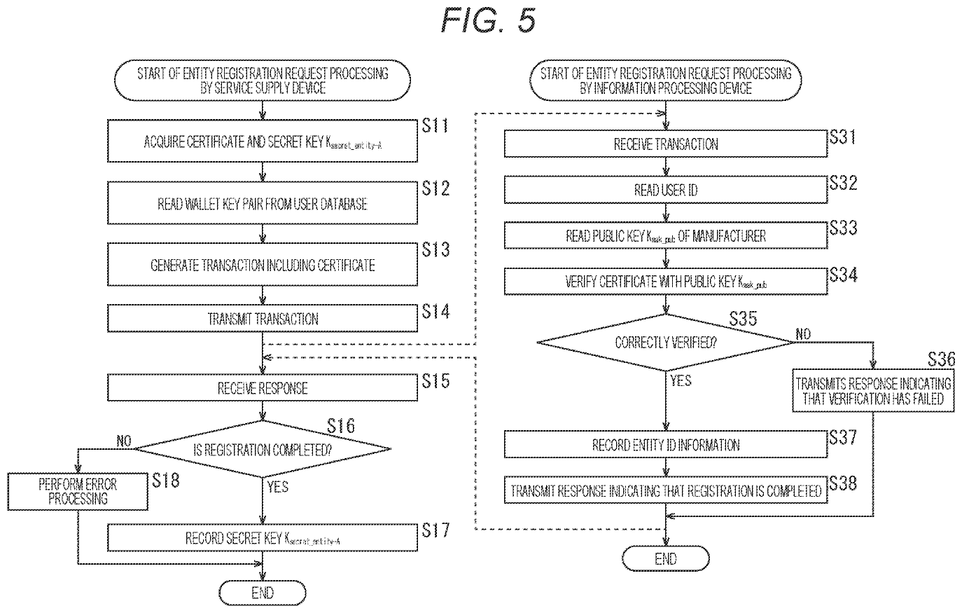

Hereinafter, a specific example of processing performed in registration of the entity 12 will be described with reference to the flowchart of FIG. 5. That is, hereinafter, the entity registration request processing by the service supply device 41 and the entity registration processing by the information processing device 42 will be described with reference to the flowchart of FIG. 5.

First, in a case where the user registers the entity 12A, the output unit 126 of the entity 12A is connected to the service supply device 41. Then, the output unit 126 outputs the certificate Cert_{entity-A} of the public key K_{pub_entity-A} recorded in the recording unit 121 and the secret key K_{secret_entity-A} to the service supply device 41.

Then, in step S11, the communication unit 51 of the service supply device 41 acquires the certificate Cert_{entity-A} and the secret key K_{secret_entity-A} from the entity 12A, and supplies the certificate Cert_{entity-A} and the secret key K_{secret_entity-A} to the control unit 52.

In step S12, the control unit 52 reads the wallet key pair from the user database of the recording unit 53.

Note that it is assumed that the user ID, the user information, and the wallet key pair are registered in the user database at this time, and the control unit 52 can specify a wallet address of the user in accordance with a certain method such as service login.

In step S13, the control unit 52 generates a transaction for requesting registration of the entity ID information eID_{A} corresponding to the entity 12A including the certificate Cert_{entity-A}, adds the wallet address and the signature using the wallet key pair, and supplies the transaction to the communication unit 51.

In step S14, the communication unit 51 transmits the transaction supplied from the control unit 52 to the information processing device 42.

Then, in the information processing device 42, in step S31, the communication unit 71 receives the transaction transmitted from the service supply device 41 and supplies the transaction to the control unit 72.

The control unit 72 verifies the signature of the transaction supplied from the communication unit 71 and extracts the certificate Cert_{entity-A} and the wallet address from the signature.

In step S32, the control unit 72 reads the user ID from the user record of the recording unit 73 on the basis of the wallet address extracted from the transaction.

For example, the control unit 72 specifies the user ID corresponding to the wallet address on the basis of the associative array recorded in the recording unit 73 and reads the user ID from the user record.

In step S33, the verification unit 81 of the control unit 72 reads the ID information mID_{A} from the certificate Cert_{entity-A} extracted from the transaction and further reads the public key K_{mak_pub} of the manufacturer corresponding to the ID information mID_{A} from the manufacturer public key record recorded in the recording unit 73.

In step S34, the verification unit 81 verifies the certificate Cert_{entity-A} with the public key K_{mak_pub}.

That is, the verification unit 81 verifies the signature S_{maker-A} included in the certificate Cert_{entity-A} with the public key K_{mak_pub}, for example, as shown in the following Expression (1).

Then, the verification unit 81 compares the entity ID information eID_{A}, the ID information mID_{A}, and the public key K_{pub_entity-A} obtained through decryption with the entity ID information eID_{A}, the ID information mID_{A}, and the public key K_{pub_entity-A} included in the certificate Cert_{entity-A}, and verifies whether they match.

[Math. 1]

Valid=Verify_{[K}_{_{mak_pub}}_{]}(eID_{A}∥mID_{A}∥K_{pub_entity-A}·S_{maker-A}) (1)

In step S35, the verification unit 81 determines whether or not the certificate Cert_{entity-A} has been correctly verified.

In a case where it is determined in step S35 that the certificate Cert_{entity-A} has not been correctly verified, that is, the verification has failed, the control unit 72 generates a response (an error response) indicating that the verification has failed and supplies the response to the communication unit 71. Thereafter, the processing proceeds to step S36.

In step S36, the communication unit 71 transmits the response which has been supplied from the control unit 72 and indicates that the verification has failed to the service supply device 41, and the entity registration processing ends.

Conversely, in a case where it is determined in step S35 that the certificate Cert_{entity-A} has been correctly verified, in step S37, the control unit 72 supplies the entity ID information eID_{A} included in the certificate Cert_{entity-A} to the recording unit 73 to record the entity ID information eID_{A}. The recording unit 73 records the entity ID information eID_{A} supplied from the control unit 72 in the entity ID record.

Thus, the entity 12A, in other words, the public key K_{pub_entity-A} of the entity 12A is registered in the blockchain 13.

Note that the entity ID information eID_{A} is obtained by obtaining a hash value of the public key K_{pub_entity-A}, for example, as shown in the following Expression (2).

[Math. 2]

eID_{A}=hash(K_{pub_entity-A}) (2)

In this example, since the public key K_{pub_entity-A} cannot be obtained from the entity ID information eID_{A}, leakage of the public key K_{pub_entity-A} can be inhibited.

In addition, the control unit 72 may generate a link for obtaining the entity ID information eID_{A} from the user ID read in step S32, supply the link to the recording unit 73, and record the link in the user record. In this case, a list of the ID information of the entities owned by the user is recorded in the user information, and the entity ID information eID_{A} obtained above is recorded in the list.

Through the foregoing processing, the registration of the entity 12A is completed. The control unit 72 generates a response indicating that the registration is completed and supplies the response to the communication unit 71.

In step S38, the communication unit 71 transmits a response which is supplied from the control unit 72 and indicates that the registration is completed to the service supply device 41, and the entity registration processing ends.

When the processing of step S36 or S38 is performed in this way, the service supply device 41 performs the processing of step S15.

That is, in step S15, the communication unit 51 receives the response transmitted from the information processing device 42 and supplies the response to the control unit 52.

In step S16, the control unit 52 determines whether or not the registration is completed. For example, in a case where the response indicating that the registration has been completed is received in step S15, it is determined that the registration is completed.

In a case where it is determined in step S16 that the registration has been completed, the control unit 52 supplies the recording unit 53 with the secret key K_{secret_entity-A} of the entity 12A and the entity ID information eID_{A} of the entity 12A acquired from the entity A in step S11. Thereafter, the processing proceeds to step S17.

In step S17, the recording unit 53 records the secret key K_{secret_entity-A} of the entity 12A supplied from the control unit 52, adds the entity ID information eID_{A} to the list of the entity ID information owned by the user in the user database, and records the entity ID information eID_{A} in association with the secret key K_{secret_entity-A}.

Then, the control unit 52 generates a message indicating that the registration has been completed and causes the communication unit 51 to output the message to the entity 12A, and the entity registration request processing ends.

Conversely, in a case where it is determined in step S16 that the registration has not been completed, that is, in a case where a response indicating that the verification has failed is received, the control unit 52 performs error processing in step S18, and the entity registration request processing ends.

For example, the control unit 52 performs, as the error processing, processing to generate a message indicating that registration has failed due to an error, supplying the message to the communication unit 51, and causing the entity 12A to output the message.

As described above, the service supply device 41 generates a transaction including the certificate Cert_{entity-A} acquired from the entity 12A, transmits the transaction to the information processing device 42, and records the secret key K_{secret_entity-A} in accordance with the response from the information processing device 42. In addition, the information processing device 42 records the entity ID information eID_{A} in accordance with the transaction received from the service supply device 41.

In this way, it is possible to inhibit privacy damage to the user.

Specifically, for example, since the public key K_{pub_entity-A} of the entity 12A is not recorded in the blockchain 13, the public key K_{pub_entity-A} is not leaked even if the blockchain 13 is hacked. In addition, by recording the user ID and the entity ID information eID_{A} or the like without directly associating them, it is possible to minimize privacy damage to the user even in a case where the blockchain 13 is hacked.

<Description of File Generation Processing>

Next, processing performed in a case where a camera serving as the entity 12A performs imaging and generates File 0 using image data obtained as a result as Data 0 will be described.

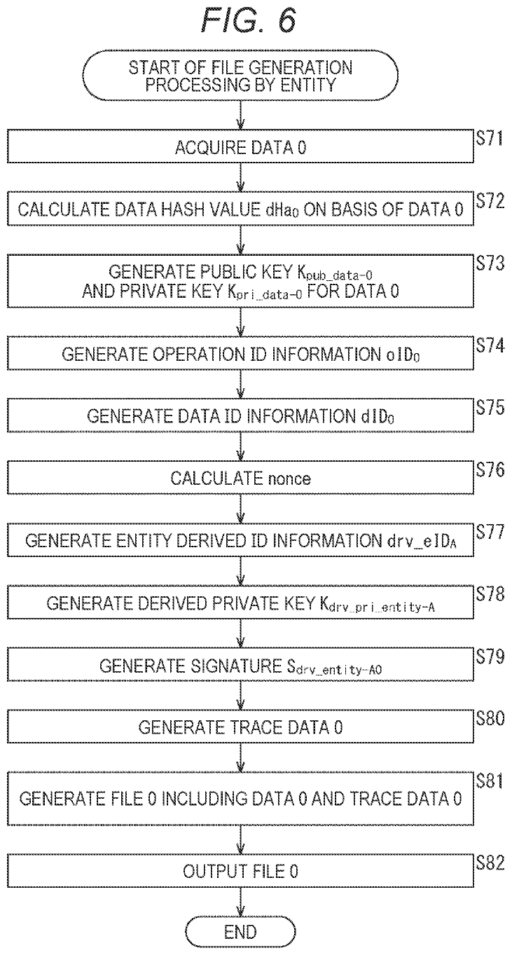

That is, hereinafter, the file generation processing performed by the entity 12A will be described with reference to the flowchart of FIG. 6.

In step S71, the file generation unit 124 acquires Data 0 generated by the data generation unit 125 from the data generation unit 125.

In step S72, the file generation unit 124 calculates the data hash value dHa₀ on the basis of the acquired Data 0.

For example, in step S72, the following Expression (3) is calculated to calculate the data hash value dHa₀. Note that, in Expression (3), Data₀ represents Data 0.

[Math. 3]

dHa₀=hash(Data₀) (3)

In addition, the file generation unit 124 reads the secret key K_{secret_entity-A} and the public key K_{pub_entity-A} of the entity 12A recorded in the recording unit 121.

In step S73, the key generation unit 122 generates the public key K_{pub_data-0} and the private key K_{pri_data-0} for Data 0 on the basis of a predetermined random number or the like and supplies the public key K_{pub_data-0} and the private key K_{pri_data-0} to the file generation unit 124.

In step S74, the file generation unit 124 generates the operation ID information oID₀ by calculating a hash value of the public key K_{pub_data-0} supplied from the key generation unit 122. For example, in step S74, the following Expression (4) is calculated to calculate the operation ID information oID₀.

[Math. 4]

oID₀=hash(K_{pub_data-0}) (4)

In step S75, the file generation unit 124 generates the data ID information dID₀ of Data 0 by calculating the data hash value dHa₀ and the hash value of the operation ID information oID₀.

For example, in step S75, the following Expression (5) is calculated to calculate the data ID information dID₀.

[Math. 5]

dID₀=hash(dHa₀∥oID₀) (5)

In step S76, the file generation unit 124 calculates a nonce by calculating the hash value of the data ID information dID₀ on the basis of the secret key K_{secret_entity-A} read from the recording unit 121.

For example, in step S76, the following Expression (6) is calculated to calculate a nonce.

[Math. 6]

nonce=HMAC_{[K}_{_{secret_entity-A}}_{]}(dID₀) (6)

Thus, a random number (a random numerical value) corresponding to the secret key K_{secret_entity-A} and the data ID information dID₀ is obtained as the nonce. The nonce changes for each data such as Data 0 and Data 1.

In this case, even if the nonce and the data ID information dID₀ are specified, the secret key K_{secret_entity-A} cannot be obtained from the information. Therefore, leakage of the secret key K_{secret_entity-A} can be inhibited. Moreover, since the nonce is not recorded in File 0 or the blockchain 13, it is possible to further inhibit the privacy damage to the user.

The file generation unit 124 supplies the obtained nonce to the derived key derivation unit 123. In addition, the derived key derivation unit 123 reads the private key K_{pri_entity-A} of the entity 12A from the recording unit 121 via the file generation unit 124.

In step S77, the file generation unit 124 generates the entity derived ID information drv_eID_{A} by calculating the hash value of the entity ID information eID_{A} on the basis of the nonce.

For example, in step S77, the following Expression (7) is calculated to generate the entity derived ID information drv_eID_{A}.

[Math. 7]

drv_eID_{A}=HMAC_{[nonce]}(eID_{A}) (7)

In step S78, the derived key derivation unit 123 generates (derives) the derived private key K_{drv_pri_entity-A} from the private key K_{pri_entity-A} read from the recording unit 121 and the nonce supplied from the file generation unit 124, and supplies the derived private key K_{drv_pri_entity-A} to the file generation unit 124.

For example, in step S78, the following Expression (8) is calculated to derive the derived private key K_{drv_pri_entity-A}.

[Math. 8]

K_{drv_pri_entity-A}=K_{pri_entity-A}+nonce (8)

By deriving the derived private key K_{drv_pri_entity-A} using the private key K_{pri_entity-A} and nonce in this way, the derived private key K_{drv_pri_entity-A} used for the signature can be randomized. Thus, it is possible to inhibit leakage of the private key K_{pri_entity-A} and the secret key K_{secret_entity-A}. As a result, it is possible to inhibit privacy damage to the user.

In step S79, the file generation unit 124 generates the signature S_{drv_entity-A0}.

For example, the file generation unit 124 calculates the following Expression (9) to obtain the hash value of the data ID information dID₀, the public key K_{pub_data-0}, the operation ID information oID₀, and the entity derived ID information drv_eID_{A} as the Msg hash value mHa₀. The Msg hash value mHa₀ is a hash value of the certificate message including the data ID information dID₀, the public key K_{pub_data-0}, the operation ID information oID₀, and the entity derived ID information drv_eID_{A}.

[Math. 9]

mHa₀=hash(dID₀∥K_{pub_data-0}∥oID₀∥drv_eID_{A}) (9)

Further, the file generation unit 124 calculates the following Expression (10) to sign (encrypt) the obtained Msg hash value mHa₀ with the derived private key K_{drv_pri_entity-A} and generate the signature S_{drv_entity-A0}.

[Math. 10]

S_{drv_entity-A0}=Sign_{K}_{_{dev_pri_entity-A}}(mHa₀) (10)

In step S80, the file generation unit 124 generates Trace Data 0.

Specifically, the file generation unit 124 generates Certificate 0 (cCERT₀) including the data ID information dID₀, the operation ID information oID₀, the public key K_{pub_data-0}, the entity derived ID information drv_eID_{A}, and the signature S_{drv_entity-A0}.

Then, the file generation unit 124 generates Trace Data 0 including Certificate 0 and the private key K_{pri_data-0}.

In step S81, the file generation unit 124 generates File 0 including Data 0 and Trace Data 0, and supplies File 0 to the output unit 126.

In step S82, the output unit 126 outputs File 0 supplied from the file generation unit 124, and the file generation processing ends.

For example, the output unit 126 outputs File 0 to the service supply device 41 to request registration of Data 0 in the blockchain 13, or outputs File 0 to the entity 12B.

As described above, the entity 12A generates and outputs File 0 including Data 0 and Trace Data 0. In this way, it is possible to inhibit privacy damage to the user.

For example, Trace Data 0 includes the signature S_{drv_entity-A0} generated on the basis of the derived private key K_{drv_pri_entity-A}. However, since the derived public key K_{drv_pub_entity-A} can be obtained from the signature S_{drv_entity-A0} and the public key K_{pub_entity-A} of the entity 12A cannot be obtained, it is possible to inhibit leakage of the public key K_{pub_entity-A}.

In addition, the nonce, the entity ID information, and the private key change for each piece of data generated by the entity 12, and the trace data is generated using the entity derived ID information and the derived private key derived on the basis of the nonce.

Accordingly, since the entity 12 cannot be identified from the trace data, that is, the signature such as the signature S_{drv_entity-A0}, it is possible to further inhibit privacy damage to the user.

<Description of Data Registration Request Processing and Data Registration Processing>

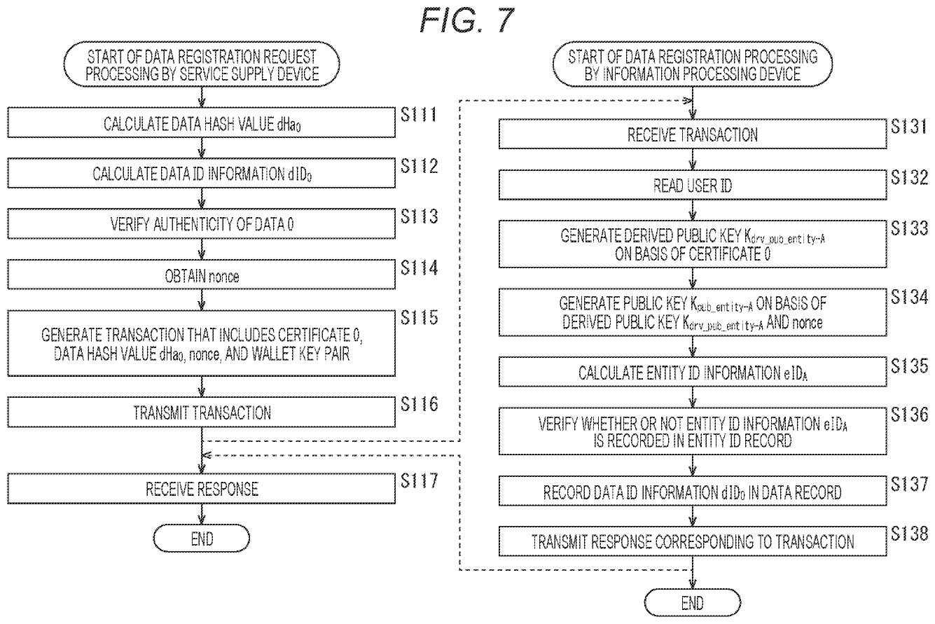

In addition, when File 0 is supplied from the entity 12A to the service supply device 41 and a request for registering Data 0 (file 0) in the blockchain 13 is given, the service supply device 41 and the information processing device 42 perform the processing illustrated in FIG. 7.

At this time, the entity 12A can request association between Data 0 and the user ID in the blockchain 13 in response to an input operation or the like of the user.

Hereinafter, data registration request processing by the service supply device 41 and data registration processing by the information processing device 42 will be described with reference to the flowchart of FIG. 7.

When the communication unit 51 of the service supply device 41 acquires File 0 from the entity 12A and supplies File 0 to the control unit 52, the service supply device 41 starts the data registration request processing.

In step S111, the verification unit 61 of the control unit 52 calculates the data hash value dHa₀ on the basis of Data 0 included in File 0 supplied from the communication unit 51. For example, in step S111, the above-described calculation of Expression (3) is performed to calculate the data hash value dHa₀.

In step S112, the verification unit 61 calculates a hash value of the data hash value dHa₀ and the operation ID information oID₀ included in Certificate 0 of File 0 and calculates the data ID information dID₀ of Data 0. For example, the verification unit 61 calculates the data ID information dID₀ by calculating Expression (5) described above.

In step S113, the verification unit 61 compares the data ID information dID₀ calculated in step S112 with the data ID information dID₀ included in Certificate 0 of File 0 supplied from the communication unit 51 and verifies the authenticity of Data 0.

Here, in a case where the data ID information dID₀ is matched, it is determined that the authenticity of Data 0 has been correctly verified.

When the authenticity of Data 0 is correctly verified, the control unit 52 reads the secret key K_{secret_entity-A} of the entity 12A and the wallet key pair from the user database of the recording unit 53.

Note that, in a case where the data ID information dID₀ is not matched in the verification of the authenticity, the control unit 52 performs error processing similar to step S18 of FIG. 5 and transmits a message indicating that registration has failed due to the error to the entity 12A.

In step S114, the generation unit 62 obtains the nonce by calculating a hash value of the data ID information dID₀ of Data 0 on the basis of the secret key K_{secret_entity-A}. Note that the data ID information dID₀ used for calculation of the nonce may be calculated from Data 0 by the verification unit 61 or may be included in Certificate 0.

For example, the generation unit 62 calculates the nonce in accordance with Expression (6) with respect to the secret key K_{secret_entity-A} of the corresponding entity 12A of each piece of entity ID information from the list of the entity ID information included in the user information and calculates the entity derived ID information drv_eID_{A} in accordance with Expression (7) from the obtained nonce.

The generation unit 62 determines whether the entity derived ID information drv_eID_{A} obtained by calculation matches the entity derived ID information drv_eID_{A} recorded in File 0. At this time, in a case where the entity derived ID information drv_eID_{A} is matched, the file is File 0 generated from the entity 12A owned by the user, and in step S114, the same nonce as in the case of the file generation processing illustrated in the flowchart of FIG. 6 is obtained.

In step S115, the generation unit 62 generates a transaction that includes Certificate 0, the data hash value dHa₀, the nonce, the wallet key pair, a user flag, and an entity flag and requests registration of File 0 (Data 0), and supplies the transaction to the communication unit 51.

Here, the user flag is flag information indicating whether or not to record the user ID and the data ID information dID₀ in association in the blockchain 13, more specifically, in the data record. The user flag is generated by the generation unit 62 in response to a designation by the entity 12A, more specifically, the user who owns the entity 12A.

In addition, in this example, since the derived public key K_{pub_entity-A} is generated using the nonce, it is sufficient to supply the nonce to the information processing device 42, and it is not necessary for the information processing device 42 to handle the secret key K_{secret_entity-A} and the private key K_{pri_entity-A}. Thus, leakage of these keys can be inhibited.

In step S116, the communication unit 51 transmits the transaction supplied from the generation unit 62 to the information processing device 42.

Then, the information processing device 42 performs data registration processing.

That is, in step S131, the communication unit 71 receives the transaction transmitted from the service supply device 41 and supplies the transaction to the control unit 72. The control unit 72 extracts Certificate 0, the data hash value dHa₀, the nonce, the wallet address, the user flag, and the entity flag from the transaction supplied from the communication unit 71. In addition, the control unit 72 also verifies whether the transaction is generated with the corresponding wallet key pair using the wallet address and the signature of the transaction.

In step S132, the control unit 72 reads the user ID from the user record of the recording unit 73 on the basis of the wallet address. For example, in step S132, processing similar to that in step S32 in FIG. 5 is performed.

In step S133, the verification unit 81 of the control unit 72 generates the derived public key K_{drv_pub_entity-A} on the basis of Certificate 0.

For example, the verification unit 81 calculates the following Expression (11) on the basis of the data ID information dID₀, the public key K_{pub_data-0}, the operation ID information oID₀, the entity derived ID information drv_eID_{A}, and the signature S_{drv_entity-A0} included in Certificate 0, and thus calculates the derived public key K_{drv_pub_entity-A} corresponding to the derived private key K_{drv_pri_entity-A}.

[Math. 11]

K_{drv_pub_entity-A}=ECRecovery(dID₀∥K_{pub_data-0}∥oID₀∥drv_eID_{A},S_{drv_entity-A0}) (11)

By using the derived public key K_{drv_pub_entity-A} obtained in this way, it is also possible to verify the signature S_{drv_entity-A0} included in Certificate 0.

In such a case, for example, the verification unit 81 decrypts the signature S_{drv_entity-A0} with the derived public key K_{drv_pub_entity-A} to obtain the Msg hash value mHa₀ and calculates the above-described Expression (9) on the basis of each piece of information included in Certificate 0 to obtain the Msg hash value mHa₀.

Then, the verification unit 81 verifies the authenticity of Certificate 0, that is, Trace Data 0 by comparing the obtained Msg hash value mHa₀ with the Msg hash value mHa₀ obtained through decoding and verifying whether the hash values match each other.

In step S134, the verification unit 81 generates the public key K_{pub_entity-A} of the entity 12A on the basis of the derived public key K_{drv_pub_entity-A} and the nonce included in the transaction received in step S131.

For example, in step S134, the following Expression (12) is calculated to calculate the public key K_{pub_entity-A}.

[Math. 12]

K_{pub_entity-A}=K_{drv_pub_entity-A}−nonce*G (12)

Note that G represents a base point in Expression (12). Here, the public key K_{pub_entity-A} is calculated using homomorphism of an encryption scheme such as elliptic curve cryptography. In other words, in Expression (12), the public key K_{pub_entity-A} is calculated through finite field calculation on an elliptic curve in which homomorphism is used from a relationship between the private key K_{pri_entity-A} of the above-described Expression (8), and the derived public key K_{drv_pub_entity-A} and nonce.

In step S135, the verification unit 81 calculates a hash value of the public key K_{pub_entity-A} and calculates entity ID information eID_{A} of the entity 12A. For example, in step S135, the above-described Expression (2) is calculated to calculate the entity ID information eID_{A}.

In addition, the verification unit 81 obtains the entity derived ID information drv_eID_{A} from the calculated entity ID information eID_{A}, the nonce, and the above-described Expression (7) and checks whether the entity derived ID information drv_eID_{A} matches the entity derived ID information drv_eID_{A} included in Certificate 0. Thus, it is possible to verify whether the derived private key K_{drv_pri_entity-A} used for the signature (generation of the signature S_{drv_entity-A0}) is derived from the private key K_{pri_entity-A} by using nonce.

In step S136, the verification unit 81 verifies whether the entity ID information eID_{A} calculated in step S135 is recorded in advance in the entity ID record of the recording unit 73, that is, whether or not the entity 12A is registered. In other words, in step S136, it is verified whether or not the registered entity 12A generates Trace Data 0 (Certificate 0).

For example, in a case where the entity ID information eID_{A} is recorded in the entity ID record, the entity 12A is determined to be a registered entity (a device). Thereafter, the processing of step S137 is performed.

Conversely, in a case where the entity ID information eID_{A} is not recorded in the entity ID record, it is determined that the entity 12A has not been registered, and a response indicating that Data 0 has not been registered due to an error is transmitted to the service supply device 41 in step S138 to be described below.

In the blockchain 13, by registering the entity ID information in advance, even if the trace data is generated by deriving the entity ID information or the private key of the entity 12, it is possible to identify the entity 12 that has generated the file (the trace data) and verify the signature included in the file.

In step S137, the control unit 72 supplies the data ID information dID₀ included in Certificate 0 to the recording unit 73 and records the data ID information dID₀ in the data record.

In this case, when the user flag is flag information indicating that the user flag is recorded in association with the user ID, the control unit 72 supplies the user ID and the data ID information dID₀ read in step S132 to the recording unit 73, checks that the entity ID information eID_{A} is included in the list of the entity ID information of the user information corresponding to the user ID, and then records the user IDs and the data ID information dID₀ in association with each other in the data record.

In addition, when the entity flag is flag information indicating that the entity flag is recorded in association with the entity ID information, the control unit 72 records the entity ID information eID_{A} and the data ID information dID₀ in association in the data record.

Conversely, when the user flag is flag information indicating that the user flag is recorded without being associated with the user ID and the entity flag is flag information indicating that the entity flag is recorded without being associated with the entity ID information, the control unit 72 supplies only the data ID information dID₀ to the recording unit 73 and records the data ID information dID₀ in the data record.

Thus, Data 0 is registered in the blockchain 13.

Basically, in the data record, only the data ID information dID₀ is recorded, and the data ID information dID₀ is not linked with the user ID and the entity ID information eID_{A}. However, in a case in which there is a request from the user, the user ID, or the entity ID information eID_{A} and the data ID information dID₀ are recorded in association. In this way, the user can appropriately perform copyright management of Data 0 indicated by the data ID information dID₀, certification of generation of Data 0 with the specific entity 12A, or the like. In addition, by adding the operation ID information oID₀ to the data record for the recording in addition to the data ID information dID₀, it is possible to check whether authenticity of data has been checked in the verification processing.

In addition, the control unit 72 generates a message indicating that the registration of Data 0 has been completed as a response to the transaction and supplies the message to the communication unit 71.

Note that, in a case where the entity ID information is not recorded in step S136, or the like, a response indicating that Data 0 cannot be registered due to an error is generated.

In step S138, the communication unit 71 transmits the response to the transaction supplied from the control unit 72 to the service supply device 41, and the data registration processing ends.

In addition, in the service supply device 41, in step S117, the communication unit 51 receives the response transmitted from the information processing device 42 and supplies the response to the control unit 52.

When the response is received from the information processing device 42, the service supply device 41 outputs a message or the like in accordance with the response to the entity 12A, and the data registration request processing ends.

In this way, the service supply device 41 verifies the authenticity of Data 0, and requests the information processing device 42 to register Data 0. In addition, the information processing device 42 verifies Trace Data 0 in response to the request from the service supply device 41 and registers Data 0 in the blockchain 13.

At this time, by recording not Data 0 itself but the data ID information dID₀ of Data 0, it is possible to inhibit leakage of Data 0 itself or other information related to the user while certifying that Data 0 is correct without being altered or the like. That is, it is possible to inhibit privacy damage to the user.

<Description of Verification Request Processing and Verification Processing>

When Data 0 is registered in this way, any third party can verify whether Data 0 (File 0) has been registered and correct in the blockchain 13, that is, verify the authenticity of Data 0, using the blockchain 13.

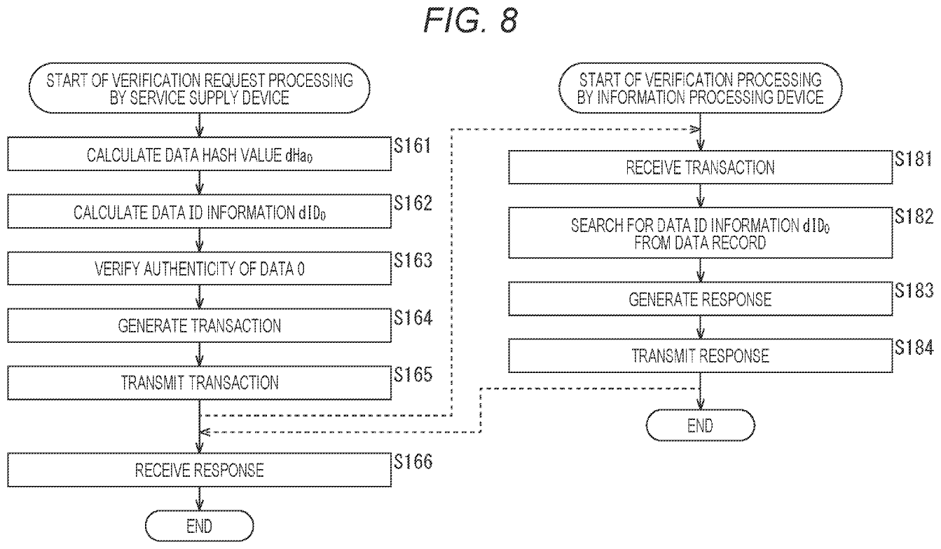

Hereinafter, processing performed in such a case will be described. That is, hereinafter, verification request processing by the service supply device 41 and verification processing by the information processing device 42 will be described with reference to the flowchart in FIG. 8.

For example, when any entity 12 supplies File 0 of Data 0 to be verified to the service supply device 41 and requests verification for Data 0, the service supply device 41 starts the verification request processing.

When the verification request processing is started, the processing of steps S161 to S163 is performed to verify the authenticity of Data 0. Since the processing is similar to the processing of steps S111 to S113 of FIG. 7, the description thereof will be omitted.

In step S164, the generation unit 62 generates a transaction that includes the data ID information dID₀ of Data 0 and the data hash value dHa₀ and requests verification of whether Data 0 is registered and correct, and supplies the transaction to the communication unit 51.

In step S165, the communication unit 51 transmits the transaction supplied from the generation unit 62 to the information processing device 42.

Then, in the information processing device 42, in step S181, the communication unit 71 receives the transaction transmitted from the service supply device 41 and supplies the transaction to the control unit 72.

The verification unit 81 of the control unit 72 extracts the data ID information dID₀ of Data 0 from the transaction supplied from the communication unit 71.

In step S182, the verification unit 81 searches for the data ID information dID₀ extracted from the transaction from the data record of the recording unit 73.

Here, in a case where the data ID information dID₀ is obtained through the searching, that is, in a case where the data ID information dID₀ is recorded in the data record, a verification result indicating that Data 0 indicated by the data ID information dID₀ is registered and correct in the blockchain 13 is obtained. In addition, for example, in a case where the user ID is associated with the data ID information dID₀, it is possible to understand which user has generated Data 0 indicated by the data ID information dID₀.

Further, in a case where the operation ID information oID₀ is recorded in the data record, the verification unit 81 check whether the data authenticity is correctly verified in the verification request by calculating the data ID information dID₀ from the data hash value dHa₀ given in the verification request and the above-described Expression (5) and checking whether the data ID information dID₀ matches the data ID information dID₀ recorded in the data record.

In step S183, the verification unit 81 generates a response including the search result in step S182 and supplies the response to the communication unit 71.

For example, in step S183, in accordance with the search result in step S182, Data 0 is registered and correct, and a message or the like indicating who is the owner is generated as a response.

In step S184, the communication unit 71 transmits the response supplied from the verification unit 81 to the service supply device 41, and the verification processing ends.

In addition, when the response is transmitted by the information processing device 42, the service supply device 41 performs the processing of step S166.

That is, in step S166, the communication unit 51 receives the response transmitted from the information processing device 42 and supplies the response to the control unit 52.

When the response is received from the information processing device 42, the service supply device 41 outputs a message or the like in accordance with the response to the entity 12, and the verification request processing ends.

In this way, the service supply device 41 verifies the authenticity of Data 0 and requests the information processing device 42 to verify whether Data 0 is registered. In addition, the information processing device 42 performs verification in response to a request from the service supply device 41 and transmits a response indicating the verification result to the information processing device 42.

By including Certificate 0 in File 0 and recording the data ID information dID₀ of Data 0 registered in the data record, it is possible to verify whether Data 0 is registered and correct even if the actual Data 0 is not recorded in the blockchain 13.

Moreover, since the public key K_{pub_entity-A} is unnecessary for the verification, it is not necessary to hold the public key K_{pub_entity-A} in the blockchain 13 or the trace data. Therefore, the public key K_{pub_entity-A} is not leaked from the blockchain 13 or the trace data, and the privacy damage to the user can be inhibited.

<Processing of Data>

Meanwhile, although File 0 including Data 0 has been described above. However, when Data 0 is processed to generate Data 1, File 1 including Data 1 is generated. When Data 1 is further processed to generate Data 2, File 2 including Data 2 is generated.

For nth (where n≥1) Data n generated from Data 0 in this way, File n is basically generated similarly to the case of File 0.

In this case, Certificate n of Data n includes the data ID information dIDₙ, the operation ID information oIDₙ, the public key K_{pub_data-n}, the entity derived ID information drv_eID_{X}, the signature S_{drv_entity-Xn}, the signature S_{data-n}, and Certificate n−1. Here, X is an index indicating the entity 12.

When the data ID information dIDₙ is calculated, calculation similar to the above-described Expression (5) is performed. When the operation ID information oIDₙ is calculated, the following Expression (13) is calculated on the basis of the public key K_{pub_data-n} and the data ID information dIDₙ₋₁.

[Math. 13]

oIDₙ=hash(K_{pub_data-n}∥dIDₙ₋₁), where dID₀=NULL (13)

In this way, since the operation ID information oIDn includes information regarding Data n−1 on which the data n is based, the operation ID information oIDₙ can be used to specify a master-slave relationship or the like.

In addition, when the entity derived ID information drv_eID_{X} is calculated, calculation similar to the above-described Expression (7) is performed. When the signature S_{drv_entity-Xn} is calculated, calculation similar to the above-described Expression (10) is performed.

Further, Certificate n of Data n includes a signature S_{data-n} that is not included in Certificate 0.

The signature S_{data-n} is obtained by calculating the following Expression (14). That is, the Msg hash value mHaₙ obtained by the calculation similar to the above-described Expression (9) is obtained by signing (encrypting) the Msg hash value mHaₙ with the private key K_{pri_data-(n-1)} of the data (n−1) included in File (n−1).

[Math. 14]

S_{data-n}=Sign_{K}_{_{pri_data-(n-1)}}(mHaₙ) (14)

The signature S_{data-n} obtained in this way can be verified with the public key K_{pub_data-(n-1)} included in Certificate (n−1) of Data (n−1) and is used for data tracing, that is, verification of a master-slave relationship.

Here, as a specific example, a case where the entity 12B generates File 1 on the basis of File 0 will be described.

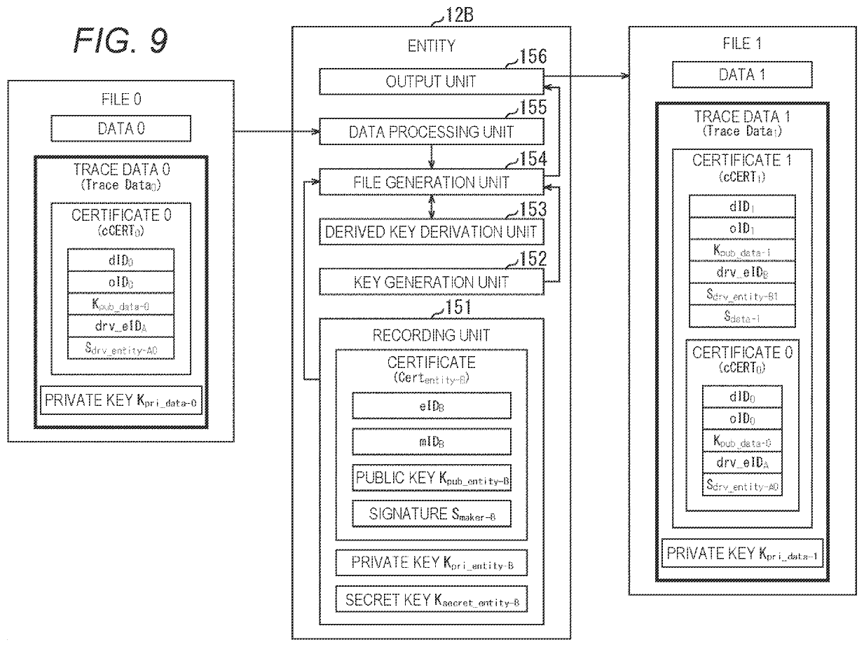

In such a case, for example, as illustrated in FIG. 9, the entity 12B acquires File 0 from the entity 12A or the like.

In this example, the entity 12B includes a recording unit 151, a key generation unit 152, a derived key derivation unit 153, a file generation unit 154, a data processing unit 155, and an output unit 156.

In addition, similarly to the case of the entity 12A, the certificate Cert_{entity-B} or the private key K_{pri_entity-B} supplied from the manufacturer device 11, and the secret key K_{secret_entity-B} generated by itself are recorded in the recording unit 151 in advance.

The data processing unit 155 performs processing on Data 0 included in File 0 to generate Data 1. The processing here is, for example, filter processing for image editing. The data processing unit 155 supplies Data 1 obtained by the processing to the file generation unit 154 along with the original File 0.

When Data 0 is processed to generate Data 1, Trace Data 1 is generated on the basis of File 0, Data 1, the certificate Cert_{entity-B}, the private key K_{pri_entity-B}, and the secret key K_{secret_entity-B}.

Specifically, the key generation unit 152 generates the private key K_{pri_data-1} and the public key K_{pub_data-1} for Data 1 on the basis of a random number or the like and supplies them to the file generation unit 154.

Next, the file generation unit 154 performs calculation similar to Expression (3) on the basis of Data 1 to calculate a data hash value dHa₁, and calculates Expression (13) on the basis of the public key K_{pub_data-1} and the data ID information dID₀ to calculate operation ID information oID₁.

In addition, the file generation unit 154 performs calculation similar to Expression (5) on the basis of the data hash value dHa₁ and the operation ID information oID₁ to calculate the data ID information dID₁ of Data 1, performs calculation similar to Expression (6) to obtain a hash value of the data ID information dID₁ on the basis of the secret key K_{secret_entity-B}, and sets the hash value as a nonce.

Further, the file generation unit 154 generates entity derived ID information drv_eID_{B} by calculating a hash value of entity ID information eID_{B} on the basis of the nonce through calculation similar to Expression (7).

The derived key derivation unit 153 performs calculation similar to Expression (8) on the basis of the nonce and the private key K_{pri_entity-B} obtained by the file generation unit 154, generates (derives) the derived private key K_{drv_pri_entity-B}, and supplies the derived private key K_{drv_pri_entity-B} to the file generation unit 154.

Then, the file generation unit 154 obtains a Msg hash value mHa₁ from the data ID information dID₁, the public key K_{pub_data-1}, the operation ID information oID₁, and the entity derived ID information drv_eID_{B} by performing calculation similar to the above-described Expression (9).

In addition, the file generation unit 154 signs (encrypts) the Msg hash value mHa₁ with the derived private key K_{drv_pri_entity-B} through calculation similar to Expression (10) and generates the signature S_{drv_entity-B1}.

Further, the file generation unit 154 calculates Expression (14) to sign (encrypt) the Msg hash value mHa₁ with the private key K_{pri_data-0} included in Trace Data 0 and generate the signature S_{data-1}.

The file generation unit 154 generates Certificate 1 (cCERT₁) of Data 1 including the data ID information dID₁, the operation ID information oID₁, the public key K_{pub_data-1}, the entity derived ID information drv_eID_{B}, the signature S_{drv_entity-B1}, the signature S_{data-1}, and Certificate 0 obtained in this way.

In addition, the file generation unit 154 generates Trace Data 1 including Certificate 1 and the private key K_{pri_data-1} and generates File 1 including Trace Data 1 and Data 1. In this case, the file generation unit 154 discards the private key K_{pri_data-0} included in the original Trace Data 0.

The file generation unit 154 supplies File 1 obtained in this way to the output unit 156, and the output unit 156 outputs File 1 supplied from the file generation unit 154.

By generating File 1 including Trace Data 1 in this way, it is possible to trace the master-slave relationship between Data 0 and Data 1 from Trace Data 1.

Specifically, for example, by verifying the signature S_{drv_entity-A0} with the derived public key K_{drv_pub_entity-A} obtained by performing the processing similar to step S133 in FIG. 7, it is possible to verify Certificate 0, that is, Data 0.

Similarly, for Certificate 1, the derived public key K_{drv_pub_entity-B} is also calculated by performing processing similar to step S133 in FIG. 7, and thus Certificate 1, that is, Data 1 can be verified.

Further, by verifying the signature S_{data-1} included in Certificate 1 with the public key K_{pub_data-0} included in Certificate 0, it is possible to verify that Data 1 is slave data of Data 0.

At this time, the Msg hash value mHa₁ is obtained from the data ID information dID₁, the operation ID information oID₁, the public key K_{pub_data-1}, and the entity derived ID information drv_eID_{B} included in Certificate 1. Then, the obtained Msg hash value mHaᵢ is compared with the Msg hash value mHa₁ obtained by decrypting the signature S_{data-1} with the public key K_{pub_data-0}, and it is verified whether the Msg hash values mHa₁ match each other.

As in File 1 as described above, when Data 1 is further processed to generate Data 2, File 2 including Data 2 is generated. File 2 is generated on the basis of File 1.

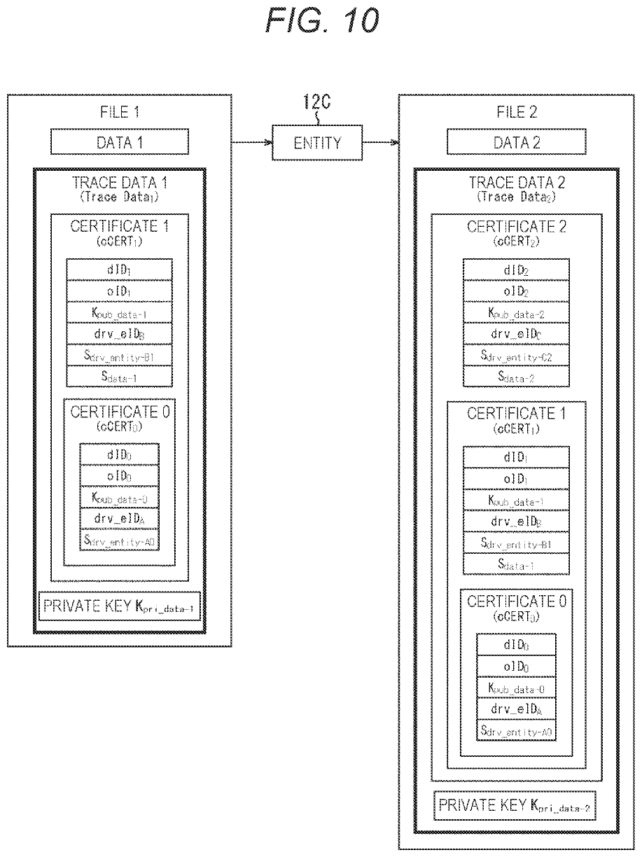

File 2 includes, for example, Data 2 and trace Data 2 as illustrated in FIG. 10, and the private key K_{pri_data-1} included in original File 1 is discarded when File 2 is generated.

In addition, Trace Data 2 includes Certificate 2 and a private key K_{pri_data-2} generated for Data 2.

In particular, Certificate 2 includes data ID information dID₂, operation ID information oID₂, a public key K_{pub_data-2}, entity derived ID information drv_eID_{c}, a signature S_{drv_entity-C2}, a signature S_{data-2}, and Certificate 1. For example, the signature S_{data-2} included in Certificate 2 is obtained through the above-described calculation of Expression (14) and can be verified with the public key K_{pub_data-1}.

Therefore, in File 2, the master-slave relationship of Data 0, Data 1, and Data 2 can be traced as in the case of File 1.

### Second Embodiment

<Exemplary Configuration of Entity>

Incidentally, the example in which if there is File n including Data n, it is possible to trace the master-slave relationship between Data n and all the data on which Data n is based has been described above. However, there is a case where tracing based on File n cannot be performed on the system.

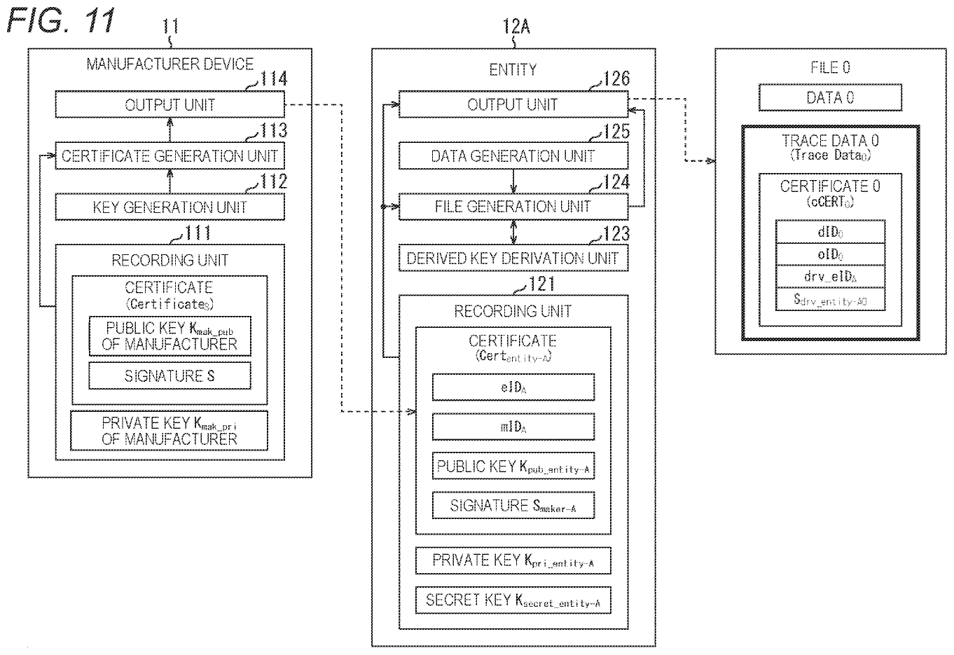

In such a case, the entity 12A has a configuration illustrated in FIG. 11. For example, File 0 is generated. Note that, in FIG. 11, portions corresponding to the case of FIG. 4 are denoted by the same reference numerals, and the description thereof will be omitted as appropriate.

The entity 12A illustrated in FIG. 11 includes the recording unit 121, the derived key derivation unit 123, the file generation unit 124, the data generation unit 125, and the output unit 126.

The configuration of the entity 12A illustrated in FIG. 11 is different from the configuration of the entity 12A illustrated in FIG. 4 in that the key generation unit 122 is not provided, and is the same as the configuration of the entity 12A in FIG. 4 in other points.

In the example of FIG. 11, since the key generation unit 122 is not included in the entity 12A, the private key K_{pri_data-0} and the public key K_{pub_data-0} for Data 0 are not generated. Therefore, in the entity 12A, as illustrated on the right side in FIG. 11, File 0 not including the private key K_{pri_data-0} and the public key K_{pub_data-0} is generated.

That is, in this example, File 0 including Data 0 and Trace Data 0 is generated. In addition, Trace Data 0 (Trace Data₀) includes Certificate 0 (cCERT₀). The Certificate 0 includes data ID information dID₀, operation ID information oID₀, entity derived ID information drv_eID_{A}, and a signature S_{drv_entity-A0} for Data 0.

Even in a case where the entity 12A has the configuration illustrated in FIG. 11, the entity 12A is registered as in the example illustrated in FIG. 4.

In such a case, the entity registration request processing and the entity registration processing described with reference to FIG. 5 are performed between the service supply device 41 and the information processing device 42.

<Description of File Generation Processing>

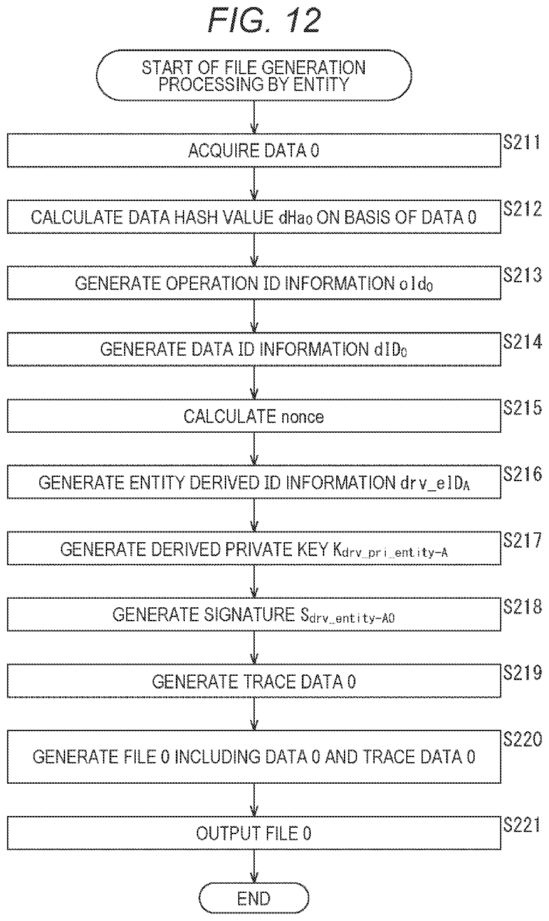

In addition, in the entity 12A, the file generation processing illustrated in FIG. 12 is performed when File 0 illustrated in FIG. 11 is generated.

Hereinafter, the file generation processing of the entity 12A will be described with reference to the flowchart of FIG. 12. Note that the processing of steps S211 to S213 is similar to the processing of steps S71, S72, and S74 in FIG. 6, and thus the description thereof will be omitted.

However, in step S213, instead of the above-described Expression (4), for example, a hash value of a random number generated for each operation is calculated and set as the operation ID information oID₀.

In step S214, the file generation unit 124 calculates a hash value of the data hash value dHa₀ and the operation ID information oID₀, and generates the data ID information dID₀ of Data 0. For example, in step S214, the above-described Expression (5) is calculated to calculate the data ID information dID₀.

When the data ID information dID₀ is calculated in this way, the processing of steps S215 to S217 is then performed. However, since these processing are similar to the processing of steps S76 to S78 of FIG. 6, the description thereof will be omitted.

In step S218, the file generation unit 124 generates the signature S_{drv_entity-A0}.

For example, the file generation unit 124 calculates the Msg hash value mHa₀ by calculating the following Expression (15) and obtaining the hash value of the data ID information dID₀, the operation ID information oID₀, and the entity derived ID information drv_eID_{A}.

[Math. 15]

mHa₀=hash(dID₀∥oD₁∥drv_eID_{A}) (15)

Further, the file generation unit 124 calculates the above-described Expression (10) and generates the signature S_{drv_entity-A0} by signing (encrypting) the obtained Msg hash value mHa₀ with the derived private key K_{drv_pri_entity-A}.

In step S219, the file generation unit 124 generates Trace Data 0.

That is, the file generation unit 124 generates Certificate 0 (cCERT₀) including the data ID information dID₀, the operation ID information oID₀, the entity derived ID information drv_eID_{A}, and the signature S_{drv_entity-A0} and generates Trace Data 0 including Certificate 0.

After Trace Data 0 is generated, the processing of steps S220 and S221 are performed and the file generation processing ends. However, since the processing is similar to the processing of steps S81 and S82 of FIG. 6, the description thereof is omitted.

As described above, the entity 12A generates and outputs File 0 including Data 0 and Trace Data 0. In this way, it is possible to inhibit privacy damage to the user.

In addition, when File 0 is supplied from the entity 12A to the service supply device 41 and a request to register Data 0 (File 0) in the blockchain 13 is given, the service supply device 41 and the information processing device 42 perform the processing described with reference to FIG. 7.

However, when the data ID information dID₀ in step S112 is calculated, as in the case of step S213 in FIG. 12, instead of the above-described Expression (4), a hash value of a random number generated for each operation is calculated to the operation ID information oID₀.

In addition, in step S133, instead of the above-described Expression (11), the following Expression (16) is calculated to generate the derived public key K_{drv_pub_entity-A}.

[Math. 16]

K_{drv_pub_entity-A}=ECRecovery(dID₀∥oID₀∥drv_eID_{A},S_{drv_entity-A0}) (16)

In Expression (16), the derived public key K_{drv_pub_entity-A} is calculated on the basis of the data ID information dID₀, the operation ID information oID₀, the entity derived ID information drv_eID_{A}, and the signature S_{drv_entity-A0}.

In addition, when Data 0 is registered, any third party can verify whether Data 0 is registered and correct in the blockchain 13 using the blockchain 13. In such a case, the verification request processing and the verification processing described with reference to FIG. 8 are performed between the service supply device 41 and the information processing device 42.

<Processing of Data>

In addition, in the example illustrated in FIG. 11, when Data 0 is processed to generate Data 1, File 1 including Data 1 is generated. When Data 1 is further processed to generate Data 2, File 2 including Data 2 is generated.

For nth (where n≥1) Data n generated from Data 0 in this way, File n is basically generated similarly to the case of File 0.

In this case, Certificate n of Data n includes the data ID information dIDₙ, the operation ID information oIDₙ, the entity derived ID information drv_eID_{X}, the signature S_{drv_entity-Xn}, and Certificate n−1. Here, X is an index indicating the entity 12.

When the data ID information dIDₙ is calculated, calculation similar to the above-described Expression (5) is performed. In addition, the operation ID information oIDₙ is, for example, a hash value of the data ID information dIDₙ₋₁.

In addition, when the entity derived ID information drv_eID_{X} is calculated, calculation similar to the above-described Expression (7) is performed. When the signature S_{drv_entity-Xn} is calculated, calculation similar to the above-described Expression (10) is performed. However, when the Msg hash value mHaₙ is calculated, calculation similar to the above-described Expression (15) is performed.

Here, as a specific example, a case where the entity 12B generates File 1 on the basis of File 0 will be described.

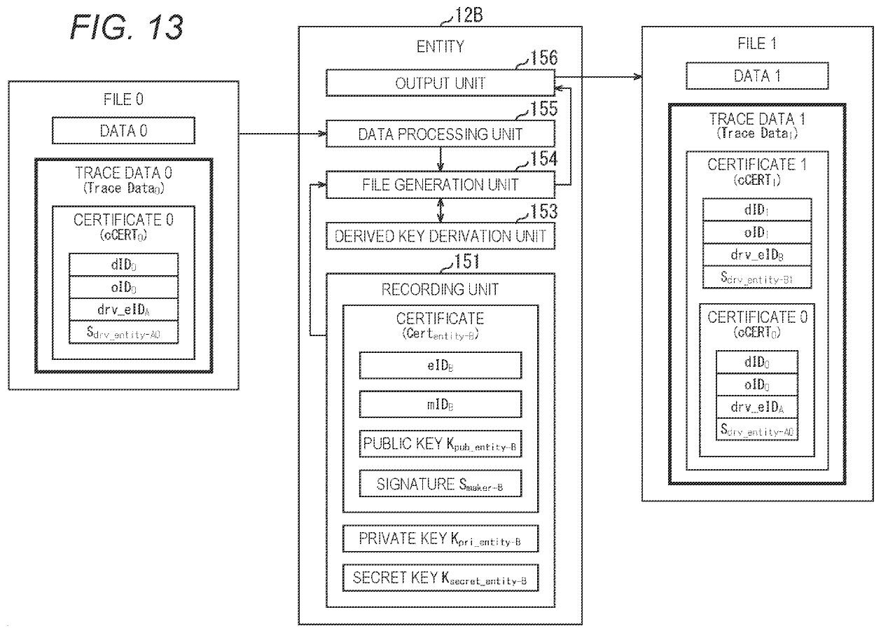

In such a case, for example, as illustrated in FIG. 13, the entity 12B acquires File 0 from the entity 12A or the like. Note that, in FIG. 13, portions corresponding to those in FIG. 9 are denoted by the same reference numerals, and description thereof will be omitted.

In this example, the data processing unit 155 performs processing on Data 0 included in File 0 to generate Data 1 and supplies the generated Data 1 to the file generation unit 154 along with File 0.

Then, the file generation unit 154 generates Trace Data 1 on the basis of File 0, Data 1, the certificate Cert_{entity-B}, the private key K_{pri_entity-B}, and the secret key K_{secret_entity-B}.

Specifically, the file generation unit 154 performs calculation similar to the Expression (3) on the basis of Data 1, calculates the data hash value dHa₁, and obtains the hash value of the data ID information dID₀ as the operation ID information oID₁.

In addition, the file generation unit 154 performs calculation similar to Expression (5) on the basis of the data hash value dHa₁ and the operation ID information oID₁ to calculate the data ID information dID₁ of Data 1, performs calculation similar to Expression (6) to obtain a hash value of the data ID information dID₁ on the basis of the secret key K_{secret_entity-B}, and sets the hash value as a nonce.

Further, the file generation unit 154 generates entity derived ID information drv_eID_{B} by calculating a hash value of entity ID information eID_{B} on the basis of the nonce through calculation similar to Expression (7).

The derived key derivation unit 153 performs calculation similar to Expression (8) on the basis of the nonce and the private key K_{pri_entity-B} obtained by the file generation unit 154, generates (derives) the derived private key K_{drv_pri_entity-B}, and supplies the derived private key K_{drv_pri_entity-B} to the file generation unit 154.

Then, the file generation unit 154 obtains the Msg hash value mHa₁ from the data ID information dID₁, the operation ID information oID₁, and the entity derived ID information drv_eID_{B} by performing calculation similar to the above-described Expression (15).

In addition, the file generation unit 154 signs (encrypts) the Msg hash value mHa₁ with the derived private key K_{drv_pri_entity-B} through calculation similar to Expression (10) and generates the signature S_{drv_entity-B1}.

The file generation unit 154 generates Certificate 1 (cCERT₁) of Data 1 including the data ID information dID₁, the operation ID information oID₁, the entity derived ID information drv_eID_{B}, the signature S_{drv_entity-B1}, and Certificate 0 obtained as described above.

In addition, the file generation unit 154 generates Trace Data 1 including Certificate 1 and generates File 1 including Trace Data 1 and Data 1.

The file generation unit 154 supplies File 1 obtained in this way to the output unit 156, and the output unit 156 outputs File 1 supplied from the file generation unit 154.

As described above, even in the case where Certificate n of Data n does not include the public key K_{pub_data-n} or the signature S_{data-n}, it is possible to inhibit privacy damage to the user.

### Third Embodiment

<Modifications of Certificate Message>

Note that, in the embodiments illustrated in FIGS. 4 and 11, the derived key derivation unit 123 generates (derives) the derived private key K_{drv_pri_entity-A} of the entity 12A derived from the private key K_{pri_entity-A} on the basis of the private key K_{pri_entity-A} and the like supplied from the file generation unit 124 and supplies the derived private key K_{drv_pri_entity-A} to the file generation unit 124. In addition, by generating the signature S_{drv_entity-A0} with the derived private key K_{drv_pri_entity-A}, leakage of the public key K_{pub_entity-A} is inhibited.

On the other hand, in a case where the public key of the device is prevented from being restored from the certificate included in the trace data, it is possible to prevent the public key of the device from being restored by deforming a message to be authenticated in addition to the method of deriving the signature key.

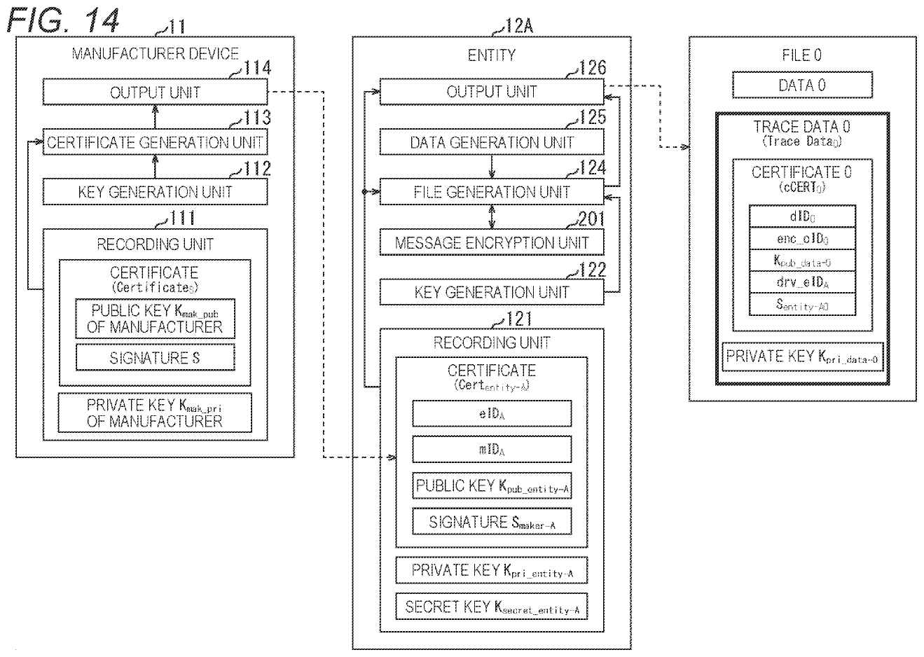

A method of transforming the certificate message in such a way is illustrated in FIG. 14. Note that, in FIG. 14, portions corresponding to those in FIG. 4 are denoted by the same reference numerals, and the description thereof will be omitted as appropriate.

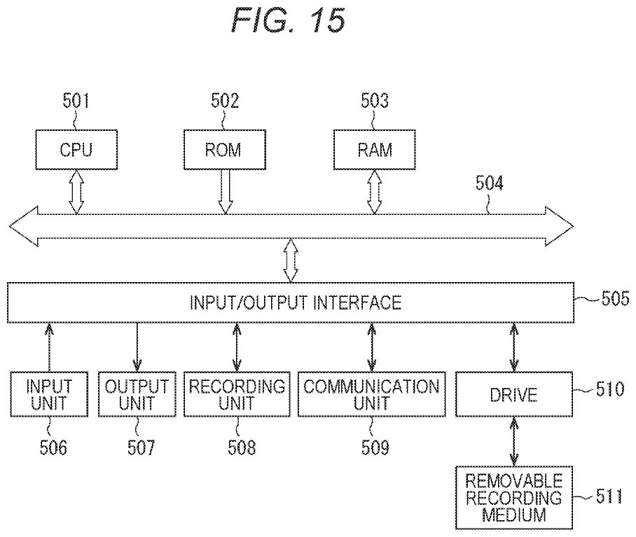

An entity 12A illustrated in FIG. 15 includes a message encryption unit 201 instead of the derived key derivation unit 123.

The file generation unit 124 obtains the Msg hash value mHa₀ from the data ID information dID₀, the public key K_{pub_data-0}, the operation ID information oID₀, and the entity derived ID information drv_eID_{A} by performing calculation similar to Expression (9) described above.

The file generation unit 124 calculates the following Expression (17) instead of the above-described Expression (10), generates a signature S_{entity-A}n by signing (encrypting) the Msg hash value mHa₀ with the private key K_{pri_entity-A}, and supplies the signature S_{entity-A0} to the file generation unit 124.

[Math. 17]

S_{entity-A0}=Sign_{K}_{_{pri_entity-A}}(mHa₀) (17)

Thereafter, the message encryption unit 201 sets the nonce supplied from the file generation unit 124 as an encryption key, encrypts the operation ID information oID₀, which is a part of the certificate message to be authenticated, with the nonce serving as an encryption key as shown in the following Expression (18), and supplies the encrypted operation ID information oID₀ to the file generation unit 124. At this time, for example, an advanced encryption standard (AES) encryption with a key length of 256 bits is used.

[Math. 18]

enc_oID₀=Enc_{nonce}(oID₀) (18)

The file generation unit 124 generates Certificate 0 of Data 0 including the data ID information dID₀, encrypted operation ID information enc_oID₀, the public key K_{pub_data-0}, the entity derived ID information drv_eID_{A}, and the signature S_{entity-A0} as illustrated on the right side in the drawing by replacing the operation ID information oID₀ that is a part of the certificate message with the encrypted operation ID information enc_oID₀ obtained by calculating Expression (18)

In this case, Certificate 0 includes a certificate message including the encrypted operation ID information enc_oID₀ obtained through the encryption with nonce, the data ID information dID₀, the public key K_{pub_data-0}, and the entity derived ID information drv_eID_{A}, in which the operation ID information oID₀ which is a part of the original certificate message is replaced.

In addition, the file generation unit 124 generates Trace Data 0 including the generated Certificate 0 and the private key K_{pri_data-0} and generates File 0 including Trace Data 0 and Data 0.

In this example, in the data registration process, the nonce is given as an encryption key. Then, the verification unit 81 performs decryption processing on the encrypted operation ID information enc_oID₀ by calculating the following Expression (19) using the nonce as an encryption key to obtain the operation ID information oID₀. Further, the verification unit 81 generates (restores) the public key K_{pub_entity-A} of the entity 12A by calculating the following Expression (20) on the basis of the operation ID information oID₀ and Certificate 0.

[Math. 19]

OID₀=Dec_{nonce}(enc_oID₀) (19)

[Math. 20]

K_{pub_entity-A}=ECRecovery(dID₀∥K_{pub_data-0}∥oID₀∥drv_eID_{A}) (20)

The verification unit 81 calculates the entity ID information eID_{A} by calculating the above-described Expression (2) on the basis of the calculated public key K_{pub_entity-A}. Further, the verification unit 81 obtains the entity derived ID information drv_eID_{A} from the calculated entity ID information eID_{A} and nonce and the above-described Expression (7), and checks whether the entity derived ID information drv_eID_{A} matches the entity derived ID information drv_eID_{A} included in Certificate 0. Thus, it is possible to verify that the signature S_{entity-A0} is signed with the private key K_{pri_entity-A} of the entity 12A. The control unit 52 of the service supply device 41 can also perform processing similar to the processing performed by the verification unit 81.

<Exemplary Configuration of Computer>

Incidentally, the above-described series of processing can be executed by hardware or software. In a case where the series of processing is executed by software, a program of the software is installed in a computer. Here, the computer is, for example, a computer incorporated in dedicated hardware, a general-purpose personal computer capable of executing various functions by installing various programs, or the like.

FIG. 15 is a block diagram illustrating an exemplary hardware configuration of a computer that executes the above-described series of processing in accordance with a program.

In the computer, a central processing unit (CPU) 501, a read-only memory (ROM) 502, and a random access memory (RAM) 503 are connected to each other by a bus 504.

An input/output interface 505 is further connected to the bus 504. An input unit 506, an output unit 507, a recording unit 508, a communication unit 509, and a drive 510 are connected to the input/output interface 505.

The input unit 506 includes a keyboard, a mouse, a microphone, and an imaging element. The output unit 507 includes a display and a speaker. The recording unit 508 includes a hard disk and a nonvolatile memory. The communication unit 509 includes a network interface. The drive 510 drives a removable recording medium 511 such as a magnetic disk, an optical disk, a magneto-optical disc, or a semiconductor memory.

In the computer that has the above-described configuration, for example, the CPU 501 performs the above-described series of processing by loading a program recorded in the recording unit 508 to the RAM 503 via the input/output interface 505 and the bus 504 and executing the program.

The program executed by the computer (CPU 501) can be recorded in the removable recording medium 511 serving as a package medium or the like for supply, for example. In addition, the program can be supplied via a wired or wireless transmission medium such as a local area network, the Internet, or digital satellite broadcasting.

In the computer, the program can be installed in the recording unit 508 via the input/output interface 505 by mounting the removable recording medium 511 on the drive 510. In addition, the program can be received by the communication unit 509 via a wired or wireless transmission medium and installed in the recording unit 508. Additionally, the program can be installed in the ROM 502 or the recording unit 508 in advance.

Note that the program executed by the computer may be a program performing processing in time series in the order described in the present specification or may be a program performing processing in parallel or at necessary timing such as the time of calling.

In addition, embodiments of the present technology are not limited to the above-described embodiments, and various modifications can be made without departing from the gist of the present technology.

For example, the present technology can take a configuration of cloud computing in which one function is shared and processed in cooperation by a plurality of devices via a network.

In addition, each step described in the above-described flowchart can be performed by one device or can be shared and performed by a plurality of devices.

Further, in a case where a plurality of steps of processing is included in one step, the plurality of steps of processing included in the one step can be performed by one device or can be shared and performed by a plurality of devices.

Further, the present technology can be configured as follows.

(1)

An information processing system including an entity, a gateway device, and an information processing device,

in which the entity includes

a first recording unit that records a pre-generated secret key, a private key, and a public key, and

a generation unit that generates a data ID of predetermined data on the basis of the data and calculates a nonce on the basis of the data and the secret key,

in which the generation unit

generates an entity derived ID on the basis of an entity ID for identifying the entity calculated on the basis of the public key and the nonce, and

generates a certificate of the data that includes a certificate message including the data ID and the entity derived ID and a signature for the certificate message with the nonce and a derived private key generated on the basis of the private key or includes a signature for the certificate message with the private key and the certificate message partially encrypted and replaced with the nonce,

in which the gateway device includes

a second recording unit that records the secret key,

a first control unit that calculates the nonce on the basis of the secret key and the certificate or the data acquired from the entity, and

a first communication unit that transmits the certificate and the nonce to the information processing device, and

in which the information processing device includes

a second communication unit that receives the certificate and the nonce transmitted by the gateway device, and

a second control unit that verifies a signature of the certificate of the entity on the basis of the certificate and the nonce.

(2)

The information processing system according to (1), in which the second control unit generates a derived public key corresponding to the derived private key on the basis of the certificate, generates the public key by finite field calculation using homomorphism on the basis of the nonce, and verifies a signature of the certificate on the basis of the entity derived ID.

(3)

The information processing system according to (2), in which the information processing device further includes a third recording unit that records the entity ID, and

in a case where the entity ID generated on the basis of the public key is recorded in the third recording unit in advance, the second control unit causes the third recording unit to record the data ID included in the certificate.

(4)

The information processing system according to (3), in which the second control unit causes the third recording unit included in a blockchain to record the data ID.

(5)

The information processing system according to any one of (2) to (4), in which the second control unit verifies the certificate on the basis of the derived public key and the entity derived ID included in the certificate.

(6)

The information processing system according to (1), in which the second control unit decrypts a part of the encrypted and replaced certificate message using the nonce as an encryption key and verifies a signature of the certificate on the basis of the entity derived ID generated on the basis of the part of the certificate message obtained through the decryption.

(7)

The information processing system according to (6), in which the second control unit generates the public key on the basis of the part of the certificate message obtained through the decryption and the certificate, calculates the entity ID on the basis of the public key, and generates the entity derived ID on the basis of the entity ID and the nonce.

(8)

The information processing system according to any one of (1) to (7), in which the entity further includes a key generation unit that generates a data private key and a data public key for the data, and

the generation unit generates the data ID on the basis of the data and the data public key and generates a file including the data, the certificate, and the data private key, and

the certificate message includes the data ID, the entity derived ID, and the data public key.

(9)

The information processing system according to (8), in which the first control unit calculates the data ID on the basis of the data included in the file acquired from the entity and the data public key and compares the calculated data ID with the data ID included in the certificate to verify authenticity of the data.

(10)

An information processing method of an information processing system including an entity that records a pre-generated secret key, a private key, and a public key, a gateway device that records the secret key, and an information processing device,

in which the entity

generates a data ID of predetermined data on the basis of the data and calculates a nonce on the basis of the data and the secret key,

generates an entity derived ID on the basis of an entity ID for identifying the entity calculated on the basis of the public key and the nonce, and

generates a certificate of the data that includes a certificate message including the data ID and the entity derived ID and a signature for the certificate message with the nonce and a derived private key generated on the basis of the private key or includes a signature for the certificate message with the private key and the certificate message partially encrypted and replaced with the nonce,

in which the gateway device

calculates the nonce on the basis of the secret key and the certificate or the data acquired from the entity, and

transmits the certificate and the nonce to the information processing device, and

in which the information processing device

receives the certificate and the nonce transmitted by the gateway device, and

verifies a signature of the certificate of the entity on the basis of the certificate and the nonce.

(11)

An entity including:

a recording unit configured to record a pre-generated secret key, a private key, and a public key; and

a generation unit configured to generate a data ID of predetermined data on the basis of the data and calculating a nonce on the basis of the data and the secret key, to generate an entity derived ID on the basis of an entity ID for identifying the entity calculated on the basis of the public key and the nonce, and to generate a certificate of the data that includes a certificate message including the data ID and the entity derived ID and a signature for the certificate message with the nonce and a derived private key generated on the basis of the private key or includes a signature for the certificate message with the private key and the certificate message partially encrypted and replaced with the nonce.

(12)

An information processing method including: by an entity recording a pre-generated secret key, a private key, and a public key,

generating a data ID of predetermined data on the basis of the data and calculating a nonce on the basis of the data and the secret key;

generating an entity derived ID on the basis of an entity ID for identifying the entity calculated on the basis of the public key and the nonce; and

generating a certificate of the data that includes a certificate message including the data ID and the entity derived ID and a signature for the certificate message with the nonce and a derived private key generated on the basis of the private key or includes a signature for the certificate message with the private key and the certificate message partially encrypted and replaced with the nonce.

(13)

A gateway device including:

a communication unit configured to acquire a certificate of predetermined data generated by an entity recording a pre-generated secret key, a private key, and a public key and the data, the certificate including a certificate message including a data ID and an entity derived ID, and a signature for the certificate message with a nonce and a derived private key generated on the basis of the private key, or the certificate including a signature for the certificate message with the private key, and the certificate message partially encrypted and replaced by the nonce;

a recording unit configured to record the secret key; and

a control unit configured to calculate the nonce on the basis of the secret key and the acquired certificate or data,

in which the communication unit transmits the certificate and the nonce to an information processing device,

the data ID is generated on the basis of the data, and

the entity derived ID is generated on the basis of the nonce and an entity ID for identifying the entity calculated on the basis of the public key.

(14)

An information processing method including: by a gateway device recording a secret key,

acquiring a certificate of predetermined data generated by an entity recording the secret key which is pre-generated, a private key, and a public key and the data, the certificate including a certificate message including a data ID and an entity derived ID, and a signature for the certificate message with a nonce and a derived private key generated on the basis of the private key, or the certificate including a signature for the certificate message with the private key, and the certificate message partially encrypted and replaced by the nonce;

calculating the nonce on the basis of the secret key and the acquired certificate or data; and

transmitting the certificate and the nonce to an information processing device,

in which the data ID is generated on the basis of the data, and

the entity derived ID is generated on the basis of the nonce and an entity ID for identifying the entity calculated on the basis of the public key.

(15)

An information processing device including:

a communication unit configured to receive a certificate of predetermined data generated by an entity recording a pre-generated secret key, a private key, and a public key and a nonce, the certificate including a certificate message including a data ID and an entity derived ID, and a signature for the certificate message with the nonce and a derived private key generated on the basis of the private key, or the certificate including a signature for the certificate message with the private key, and the certificate message partially encrypted and replaced by the nonce; and

a control unit configured to verify the signature for the certificate of the entity on the basis of the certificate and the nonce,

in which the data ID is generated on the basis of the data,

the nonce is calculated on the basis of the secret key and the certificate or the data, and

the entity derived ID is generated on the basis of the nonce and an entity ID for identifying the entity calculated on the basis of the public key.

(16)

An information processing method including: by an information processing device,

receiving a certificate of predetermined data generated by an entity recording a pre-generated secret key, a private key, and a public key and a nonce, the certificate including a certificate message including a data ID and an entity derived ID, and a signature for the certificate message with the nonce and a derived private key generated on the basis of the private key, or the certificate including a signature for the certificate message with the private key, and the certificate message partially encrypted and replaced by the nonce; and

verifying the signature for the certificate of the entity on the basis of the certificate and the nonce,

in which the data ID is generated on the basis of the data,

the nonce is calculated on the basis of the secret key and the certificate or the data, and

the entity derived ID is generated on the basis of the nonce and an entity ID for identifying the entity calculated on the basis of the public key.

### REFERENCE SIGNS LIST

11 Manufacturer device
12A to 12C, 12 Entity
13 Blockchain
41 Service supply device
42 Information processing device
51 Communication unit
52 Control unit
71 Communication unit
72 Control unit
121 Recording unit
122 Key generation unit
123 Derived key derivation unit
124 File generation unit
125 Data generation unit
126 Output unit

1. An information processing system comprising an entity, a gateway device, and an information processing device,
wherein the entity includes
a first recording unit that records a pre-generated secret key, a private key, and a public key, and
a generation unit that generates a data ID of predetermined data on a basis of the data and calculates a nonce on a basis of the data and the secret key,
wherein the generation unit
generates an entity derived ID on a basis of an entity ID for identifying the entity calculated on a basis of the public key and the nonce, and
generates a certificate of the data that includes a certificate message including the data ID and the entity derived ID and a signature for the certificate message with the nonce and a derived private key generated on a basis of the private key or includes a signature for the certificate message with the private key and the certificate message partially encrypted and replaced with the nonce,
wherein the gateway device includes
a second recording unit that records the secret key,
a first control unit that calculates the nonce on a basis of the secret key and the certificate or the data acquired from the entity, and
a first communication unit that transmits the certificate and the nonce to the information processing device, and
wherein the information processing device includes
a second communication unit that receives the certificate and the nonce transmitted by the gateway device, and
a second control unit that verifies a signature of the certificate of the entity on a basis of the certificate and the nonce.

2. The information processing system according to claim 1, wherein the second control unit generates a derived public key corresponding to the derived private key on a basis of the certificate, generates the public key by finite field calculation using homomorphism on a basis of the nonce, and verifies a signature of the certificate on a basis of the entity derived ID.

3. The information processing system according to claim 2, wherein the information processing device further includes a third recording unit that records the entity ID, and
in a case where the entity ID generated on a basis of the public key is recorded in the third recording unit in advance, the second control unit causes the third recording unit to record the data ID included in the certificate.

4. The information processing system according to claim 3, wherein the second control unit causes the third recording unit included in a blockchain to record the data ID.

5. The information processing system according to claim 2, wherein the second control unit verifies the certificate on a basis of the derived public key and the entity derived ID included in the certificate.

6. The information processing system according to claim 1, wherein the second control unit decrypts a part of the encrypted and replaced certificate message using the nonce as an encryption key and verifies a signature of the certificate on a basis of the entity derived ID generated on a basis of the part of the certificate message obtained through the decryption.

7. The information processing system according to claim 6, wherein the second control unit generates the public key on a basis of the part of the certificate message obtained through the decryption and the certificate, calculates the entity ID on a basis of the public key, and generates the entity derived ID on a basis of the entity ID and the nonce.

8. The information processing system according to claim 1, wherein the entity further includes a key generation unit that generates a data private key and a data public key for the data, and
the generation unit generates the data ID on a basis of the data and the data public key and generates a file including the data, the certificate, and the data private key, and
the certificate message includes the data ID, the entity derived ID, and the data public key.

9. The information processing system according to claim 8, wherein the first control unit calculates the data ID on a basis of the data included in the file acquired from the entity and the data public key and compares the calculated data ID with the data ID included in the certificate to verify authenticity of the data.

10. An information processing method of an information processing system including an entity that records a pre-generated secret key, a private key, and a public key, a gateway device that records the secret key, and an information processing device,
wherein the entity
generates a data ID of predetermined data on a basis of the data and calculates a nonce on a basis of the data and the secret key,
generates an entity derived ID on a basis of an entity ID for identifying the entity calculated on a basis of the public key and the nonce, and
generates a certificate of the data that includes a certificate message including the data ID and the entity derived ID and a signature for the certificate message with the nonce and a derived private key generated on a basis of the private key or includes a signature for the certificate message with the private key and the certificate message partially encrypted and replaced with the nonce,
wherein the gateway device
calculates the nonce on a basis of the secret key and the certificate or the data acquired from the entity, and
transmits the certificate and the nonce to the information processing device, and
wherein the information processing device
receives the certificate and the nonce transmitted by the gateway device, and
verifies a signature of the certificate of the entity on a basis of the certificate and the nonce.

11. An entity comprising:
a recording unit configured to record a pre-generated secret key, a private key, and a public key; and
a generation unit configured to generate a data ID of predetermined data on a basis of the data and calculating a nonce on a basis of the data and the secret key, to generate an entity derived ID on a basis of an entity ID for identifying the entity calculated on a basis of the public key and the nonce, and to generate a certificate of the data that includes a certificate message including the data ID and the entity derived ID and a signature for the certificate message with the nonce and a derived private key generated on a basis of the private key or includes a signature for the certificate message with the private key and the certificate message partially encrypted and replaced with the nonce.

12. An information processing method comprising: by an entity recording a pre-generated secret key, a private key, and a public key,
generating a data ID of predetermined data on a basis of the data and calculating a nonce on a basis of the data and the secret key;
generating an entity derived ID on a basis of an entity ID for identifying the entity calculated on a basis of the public key and the nonce; and
generating a certificate of the data that includes a certificate message including the data ID and the entity derived ID and a signature for the certificate message with the nonce and a derived private key generated on a basis of the private key or includes a signature for the certificate message with the private key and the certificate message partially encrypted and replaced with the nonce.

13. A gateway device comprising:
a communication unit configured to acquire a certificate of predetermined data generated by an entity recording a pre-generated secret key, a private key, and a public key and the data, the certificate including a certificate message including a data ID and an entity derived ID, and a signature for the certificate message with a nonce and a derived private key generated on a basis of the private key, or the certificate including a signature for the certificate message with the private key, and the certificate message partially encrypted and replaced by the nonce;
a recording unit configured to record the secret key; and
a control unit configured to calculate the nonce on a basis of the secret key and the acquired certificate or data,
wherein the communication unit transmits the certificate and the nonce to an information processing device,
the data ID is generated on a basis of the data, and
the entity derived ID is generated on a basis of the nonce and an entity ID for identifying the entity calculated on a basis of the public key.

14. An information processing method comprising: by a gateway device recording a secret key,
acquiring a certificate of predetermined data generated by an entity recording the secret key which is pre-generated, a private key, and a public key and the data, the certificate including a certificate message including a data ID and an entity derived ID, and a signature for the certificate message with a nonce and a derived private key generated on a basis of the private key, or the certificate including a signature for the certificate message with the private key, and the certificate message partially encrypted and replaced by the nonce;
calculating the nonce on a basis of the secret key and the acquired certificate or data; and
transmitting the certificate and the nonce to an information processing device,
wherein the data ID is generated on a basis of the data, and
the entity derived ID is generated on a basis of the nonce and an entity ID for identifying the entity calculated on a basis of the public key.

15. An information processing device comprising:
a communication unit configured to receive a certificate of predetermined data generated by an entity recording a pre-generated secret key, a private key, and a public key and a nonce, the certificate including a certificate message including a data ID and an entity derived ID, and a signature for the certificate message with the nonce and a derived private key generated on a basis of the private key, or the certificate including a signature for the certificate message with the private key, and the certificate message partially encrypted and replaced by the nonce; and
a control unit configured to verify the signature for the certificate of the entity on a basis of the certificate and the nonce,
wherein the data ID is generated on a basis of the data,
the nonce is calculated on a basis of the secret key and the certificate or the data, and
the entity derived ID is generated on a basis of the nonce and an entity ID for identifying the entity calculated on a basis of the public key.

16. An information processing method comprising: by an information processing device,
receiving a certificate of predetermined data generated by an entity recording a pre-generated secret key, a private key, and a public key and a nonce, the certificate including a certificate message including a data ID and an entity derived ID, and a signature for the certificate message with the nonce and a derived private key generated on a basis of the private key, or the certificate including a signature for the certificate message with the private key, and the certificate message partially encrypted and replaced by the nonce; and
verifying the signature for the certificate of the entity on a basis of the certificate and the nonce,
wherein the data ID is generated on a basis of the data,
the nonce is calculated on a basis of the secret key and the certificate or the data, and
the entity derived ID is generated on a basis of the nonce and an entity ID for identifying the entity calculated on a basis of the public key.
